(19) United States
(12) Patent Application Publication
(10) Pub. No.: US 2020/0254989 A1
(43) Pub. Date: Aug. 13, 2020

(54) Hydraulic Control Device and Brake System

(71) Applicant: Hitachi Automotive Systems, Ltd., Hitachinaka-shi, Ibaraki (JP)

(72) Inventors: Takahiro KAWAKAMI, Atsugi-shi, Kanagawa (JP); Ryohei MARUO, Kawasaki-shi, Kanagawa (JP); Chiharu NAKAZAWA, Kawasaki-shi, Kanagawa (JP)

(21) Appl. No.: 15/777,020

(22) PCT Filed: Oct. 24, 2016
(86) PCT No.: PCT/JP2016/081387

§ 371 Date: May 17, 2018

(30) Foreign Application Priority Data
Nov. 20, 2015 (JP) 2015-227291

(51) Int. Cl. B60T 13/16; B60T 8/40; B60T 7/04; B60T 8/17; B60T 13/62; B60T 13/68

(52) U.S. Cl. CPC B60T 13/165; B60T 8/4081; B60T 7/042; B60T 2270/404; B60T 13/62; B60T 13/686; B60T 2270/82; B60T 8/17

(57) ABSTRACT

Provided is a hydraulic pressure control device capable of improving ease of layout. The hydraulic pressure control device includes a stroke simulator unit and a hydraulic pressure unit. The stroke simulator unit includes a stroke simulator, a simulator connection liquid passage, and a simulator connection port. The stroke simulator is independent of a master cylinder configured to generate a hydraulic pressure through a brake pedal operation, and is configured to generate a reaction force against the brake pedal operation. The simulator connection liquid passage has one end side connected to the stroke simulator, and an opposite end side. The simulator connection port is provided on the opposite end side of the simulator connection liquid passage. The stroke simulator unit is mounted to the hydraulic pressure unit. The hydraulic pressure unit includes a unit connection port and a liquid passage. The unit connection port is connected to the simulator connection port, and overlaps the simulator connection port as viewed in an axial direction of the simulator connection port. The liquid passage is connected to the unit connection port. The hydraulic pressure unit is configured to generate a hydraulic pressure in a wheel cylinder of a vehicle via the liquid passage.

### TECHNICAL FIELD

The present invention relates to a hydraulic pressure control device.

### BACKGROUND ART

Hitherto, there has been known a hydraulic pressure control device including a stroke simulator (for example, see Patent Literature 1).

### CITATION LIST

### Patent Literature

PTL 1: JP 2007-22351 A1 SUMMARY OF INVENTION

### Technical Problem

The present invention has an object to provide a hydraulic pressure control device capable of improving ease of layout.

### Solution to Problem

In a hydraulic pressure control device according to one embodiment of the present invention, a unit including a stroke simulator preferably includes a liquid passage connected to the stroke simulator.

### Advantageous Effects of Invention

Thus, the ease of layout can be improved.

### BRIEF DESCRIPTION OF DRAWINGS

FIG. 1 is a perspective view for illustrating a part of a braking system of a first embodiment.

FIG. 2 is a schematic configuration diagram for illustrating the braking system of the first embodiment.

FIG. 3 is an exploded perspective view for illustrating a first unit according to the first embodiment.

FIG. 4 is a perspective view for illustrating the first unit and a second unit according to the first embodiment which are separated from each other.

FIG. 5 is a perspective view for illustrating the second unit to which the first unit is mounted according to the first embodiment.

FIG. 6 is a front view for illustrating the second unit to which the first unit is mounted according to the first embodiment.

FIG. 7 is a rear view for illustrating the second unit to which the first unit is mounted according to the first embodiment.

FIG. 8 is a top view for illustrating the second unit to which the first unit is mounted according to the first embodiment.

FIG. 9 is a bottom view for illustrating the second unit to which the first unit is mounted according to the first embodiment.

FIG. 10 is a left side view for illustrating the second unit to which the first unit is mounted according to the first embodiment.

FIG. 11 is a right side view for illustrating the second unit to which the first unit is mounted according to the first embodiment.

FIG. 12 is a cross-sectional view as viewed in a direction indicated by arrows XII-XII of FIG. 11.

FIG. 13 is a cross-sectional view as viewed in a direction indicated by arrows XIII-XIII of FIG. 11.

FIG. 14 is a perspective view for illustrating the second unit to which the first unit is mounted according to a second embodiment.

FIG. 15 is a perspective view for illustrating the second unit to which the first unit is mounted according to a third embodiment.

### DESCRIPTION OF EMBODIMENTS

Now, embodiments of the present invention are described based on the drawings.

### First Embodiment

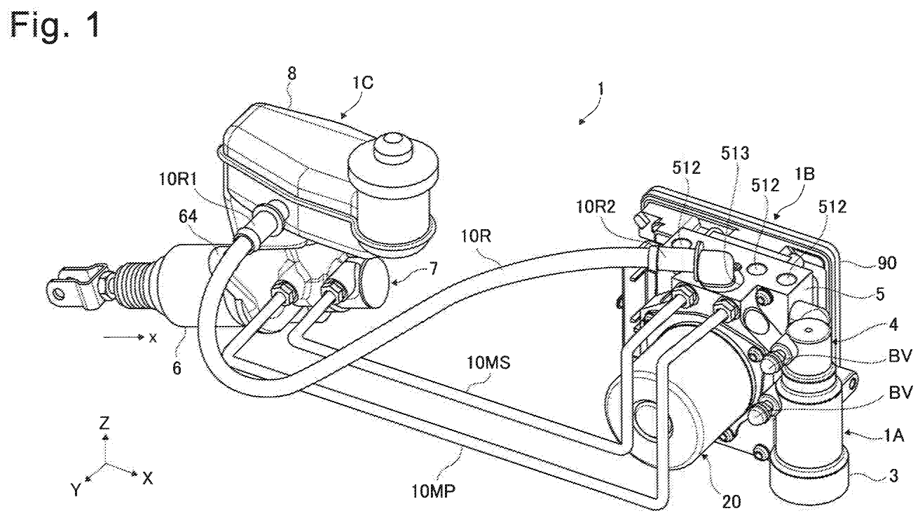

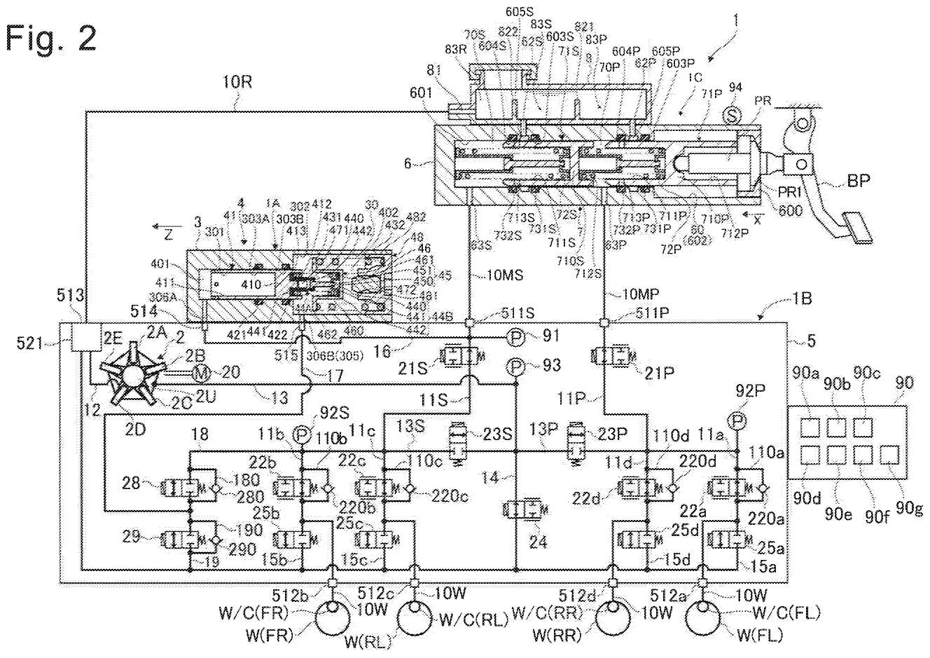

First, description is given of a configuration. FIG. 1 is an illustration of an appearance of a part of a braking system 1 of this embodiment viewed in an oblique direction. The braking system 1 includes a first unit 1A, a second unit 1B, and a third unit 1C. FIG. 2 is an illustration of a schematic configuration of the braking system 1 together with a hydraulic pressure circuit. Cross sections taken along axial centers of the first unit 1A and the third unit 1C are illustrated. The braking system 1 can be used for a general vehicle including only an internal combustion engine (engine) as a prime mover configured to drive wheels, and also for a hybrid vehicle including an electric motor (generator) in addition to an internal combustion engine, and an electric vehicle or the like including only an electric motor. The system 1 is a hydraulic pressure control device configured to apply a friction braking force with a hydraulic pressure to each of wheels W (a front left wheel FL, a front right wheel FR, a rear left wheel RL, and a rear right wheel RR) of a vehicle. A brake activation unit is provided for each of the wheels W. The brake activation unit is of; for example, a disk type, and includes a wheel cylinder W/C and a caliper. The caliper operates with a hydraulic pressure of the wheel cylinder W/C, and is configured to generate a friction braking force.

The system 1 includes two systems (primary P system and secondary S system) of brake pipes. The system 1 supplies brake fluid serving as working fluid (working liquid) to each of the brake activation units via the pipes (brake pipes) to generate a hydraulic pressure (brake pressure) in the wheel cylinder W/C. With this action, a hydraulic pressure braking force is applied to each of the wheels W. The pipe configuration is, for example, an X-split pipe configuration. Other pipe configuration such as a front-and-rear-split pipe may be employed. In the following, when a member correspondingly provided to the P system and a member correspondingly provided to the S system are distinguished from one another, suffixes P and S are added to reference numerals. The units 1A to 1C are provided in an engine room or the like partitioned from a cabin of the vehicle, and are connected to one another via master cylinder pipes 10M (primary pipe 10MP and secondary pipe 10MS) and a suction pipe 10R. The second unit 1B and the wheel cylinder W/C of each of the wheels W are connected to each other via a wheel cylinder pipe 10W. Each of the pipes 10M and 10W is a brake pipe made of metal (metal pipe). The pipe 10R is a brake hose (hose pipe) formed so as to be flexible with a material such as rubber. In the following, for the sake of description, a three-dimensional Cartesian coordinate system including an X axis, a Y axis, and a Z axis is given. Under a state in which the units 1A to 1C are mounted to the vehicle, the Z-axis direction corresponds to the vertical direction, and a positive side in the Z-axis direction corresponds to a top side in the vertical direction. An X-axis direction corresponds to a front-and-rear direction of the vehicle, and a positive side in the X-axis direction corresponds to a vehicle front side. A Y-axis direction corresponds to a lateral direction of the vehicle.

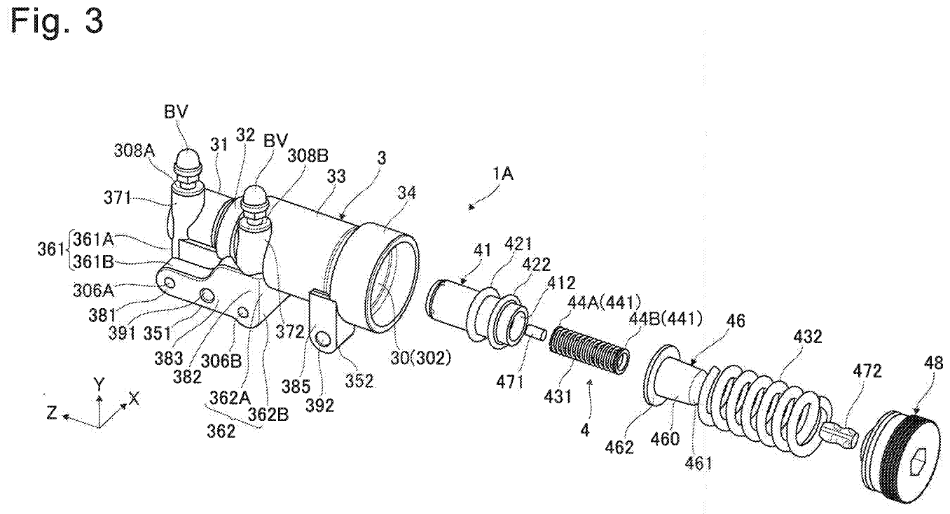

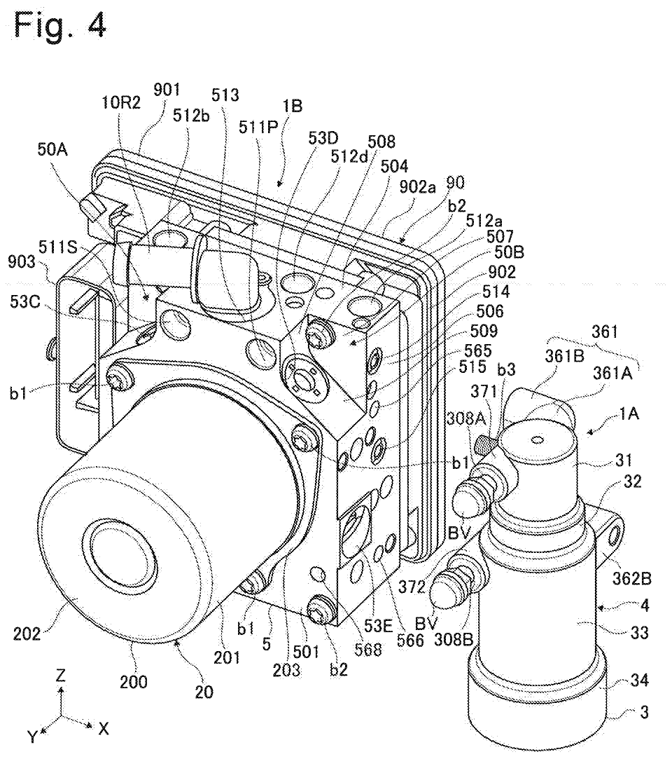

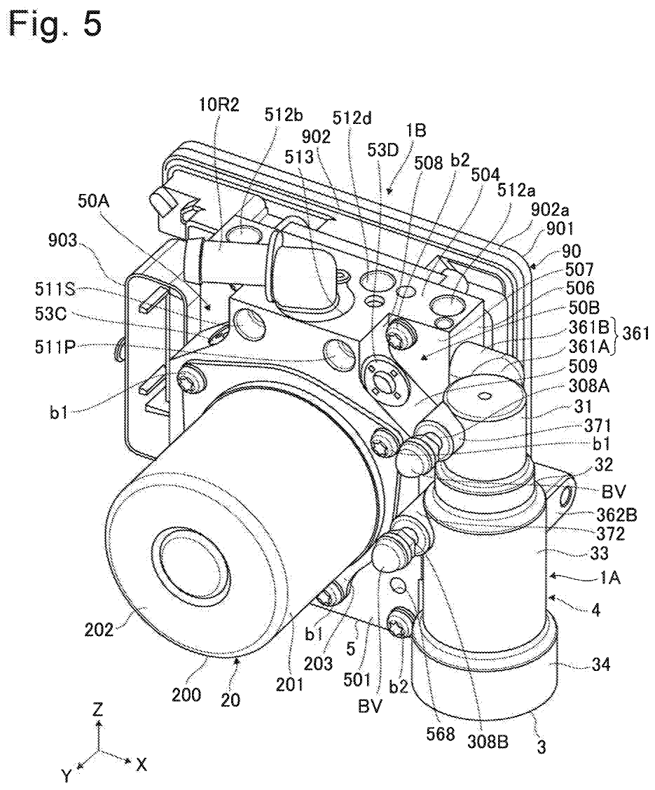

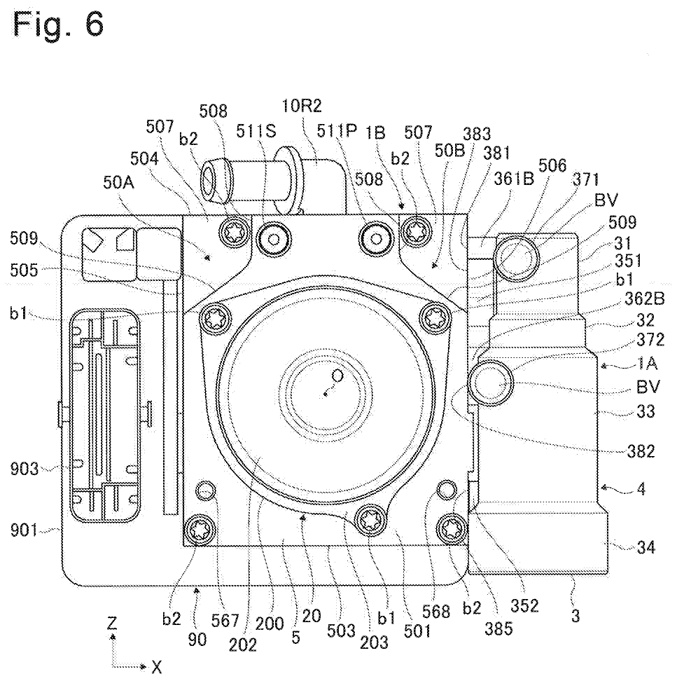

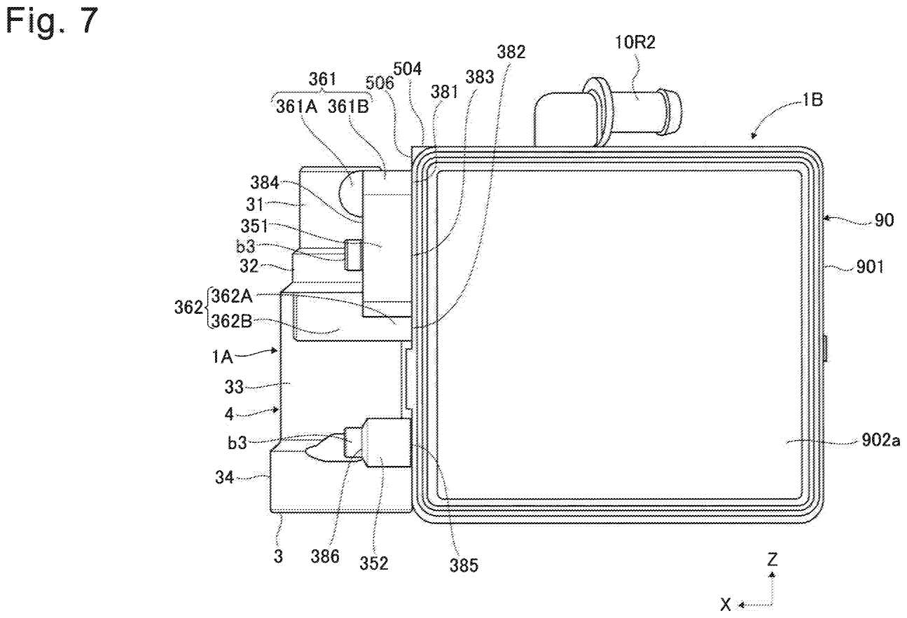

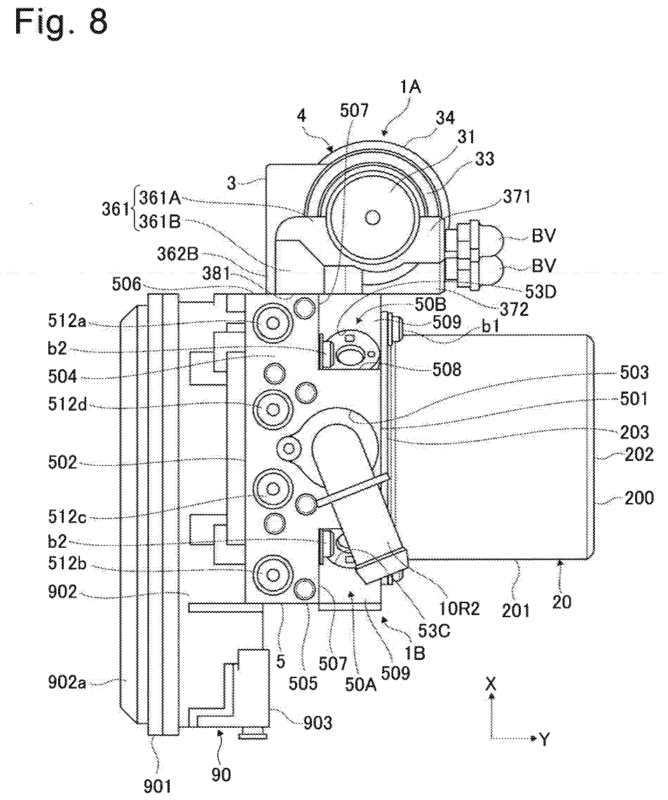

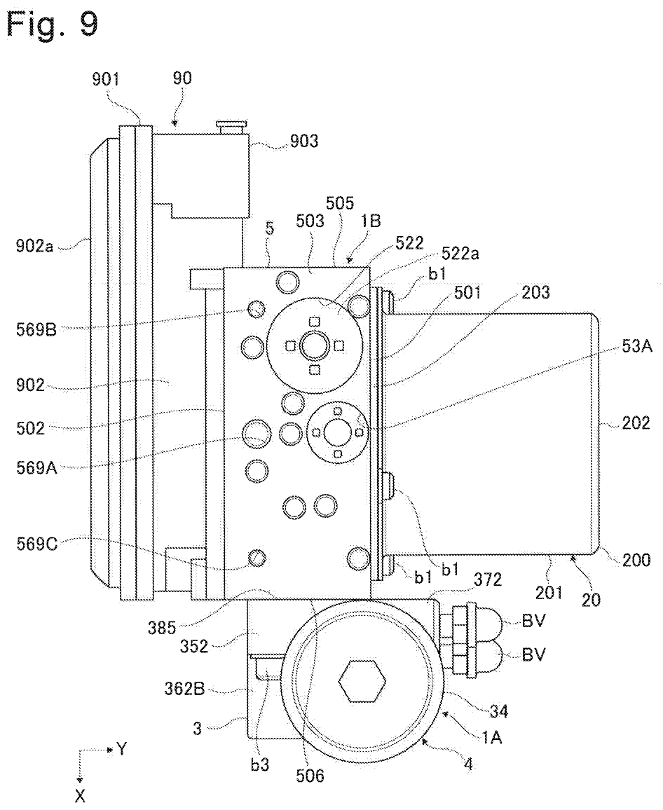

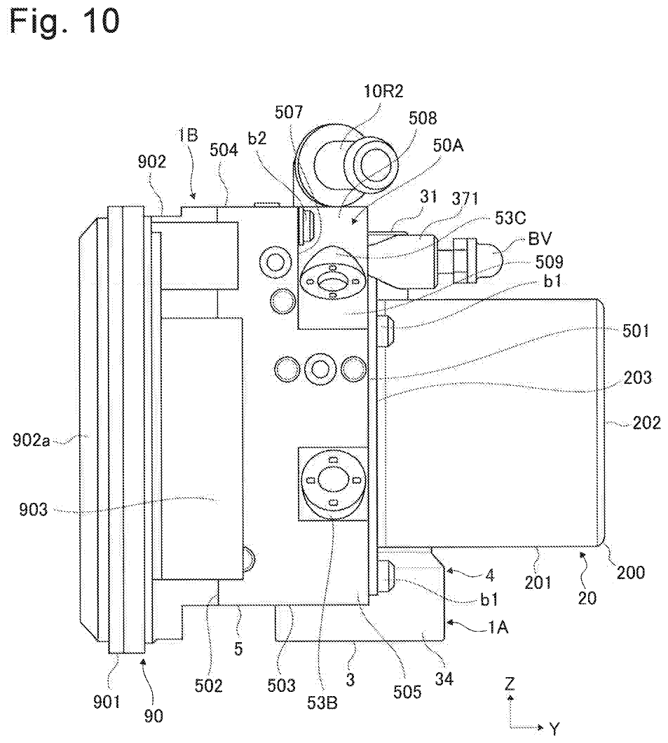

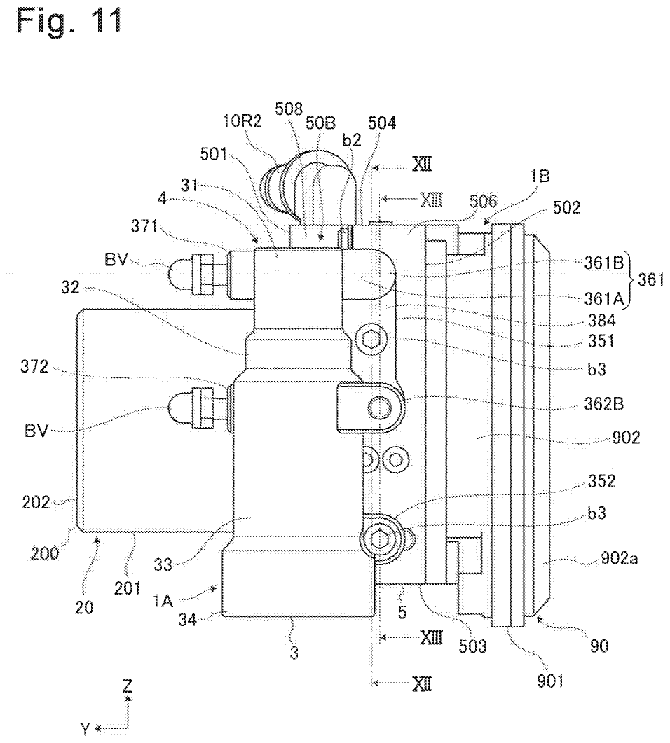

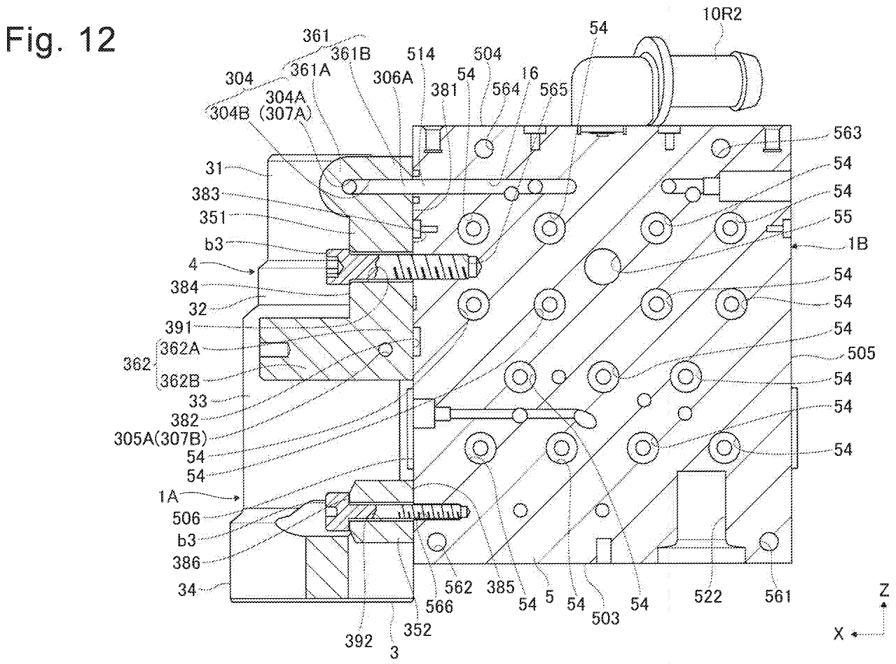

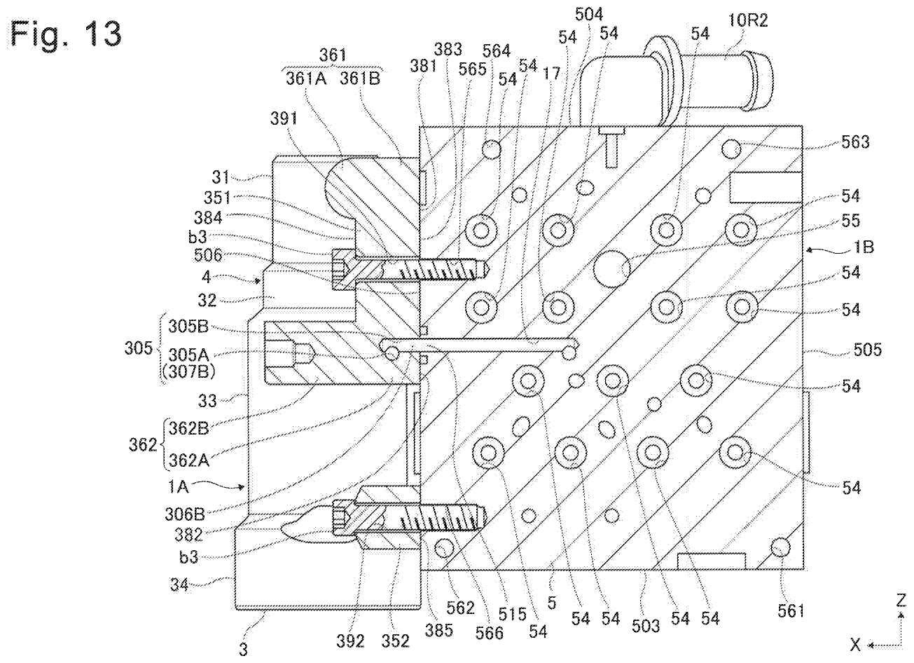

The first unit 1A is a stroke simulator unit including a stroke simulator 4. The second unit 1B is a hydraulic pressure control device provided between the master cylinder 7 and the brake activation unit for each of the wheels W. The first unit 1A and the second unit 1B are integrally provided, and are installed as a single unit in the vehicle. The third unit 1C is a brake operation unit mechanically connected to the brake pedal BP, and is a master cylinder unit including a master cylinder 7. The brake pedal BP is a brake operation member configured to receive input of a brake operation by a driver. The third unit 1C is provided independently of the first unit 1A and the second unit 1B, and is provided in the vehicle so as to be spatially separated from the first unit 1A and the second unit 1B. FIG. 3 is a perspective view for illustrating a state in which components of the first unit 1A are disassembled and arranged on the same axial center. For the sake of description, the same coordinate system as that of FIG. 1 is provided. FIG. 4 is an illustration of the first unit 1A and the second unit 1B separated from each other, as viewed in an oblique direction (from a positive side in the X-axis direction, a positive side in the Y-axis direction, and the positive side in the Z-axis direction). FIG. 5 to FIG. 11 are illustrations of an appearance of the second unit 1B to which the first unit 1A is mounted, as viewed in respective directions. FIG. 5 is a perspective view similar to that of FIG. 4. FIG. 6 is a front view as viewed from the positive side in the Y-axis direction. FIG. 6 is a rear view as viewed from a negative side in the Y-axis direction. FIG. 8 is a top view as viewed from the positive side in the Z-axis direction. FIG. 9 is a bottom view as viewed from a negative side in the Z-axis direction. FIG. 10 is a left side view as viewed from a negative side in the X-axis direction. FIG. 11 is a right side view as viewed from the positive side in the X-axis direction. FIG. 12 is a cross-sectional view as viewed in a direction indicated by arrows XII-XII of FIG. 11. FIG. 13 is a cross-sectional view as viewed in a direction indicated by arrows XIII-XIII of FIG. 11.

First, description is now given of a configuration of the first unit 1A. The first unit 1A includes a housing 3 and a stroke simulator 4. The housing 3 internally accommodates (builds in) the stroke simulator 4. The stroke simulator 4 is operated as a result of the brake operation by the driver, and applies a reaction force and a stroke to the brake pedal BP.

Parts of the housing 3 are formed by machining after a base material of the housing 3 is formed by casting with use of, for example, aluminum alloy as a material. The housing 3 has a stepped tubular shape, and includes a small-diameter part 31, an intermediate part 32, a large-diameter part 33, and an end 34 in the stated order from the positive side in the Z-axis direction toward the negative side in the Z-axis direction. Respective outer diameters of the small-diameter part 31, the intermediate part 32, the large-diameter part 33, and the end 34 increase in the stated order. The housing 3 includes a first flange part 351, a second flange part 352, a first liquid passage part 361, a second liquid passage part 362, a first bleeder part 371, and a second bleeder part 372. The flange part 351 and the like protrude outward from an outer surface of the housing 3. The first liquid passage part 361 is arranged at an end on the positive side in the Z-axis direction of the small-diameter part 31. The second liquid passage part 362 is arranged at an end on the positive side in the Z-axis direction of the large-diameter part 33. The first flange part 351 is arranged over a negative side in the Z-axis direction of the small-diameter part 31 and the intermediate part 32 (between the first liquid passage part 361 and the second liquid passage part 362 in the Z-axis direction). The second flange part 352 is arranged over the large-diameter part 33 and the end 34 in the Z-axis direction. The first liquid passage part 361 includes a first part 361A and a second part 361B. The first part 361A extends from an end on the negative side in the X-axis direction of the small-diameter part 31 toward the negative side in the Y-axis direction. The second part 361B extends from an end on the negative side in the Y-axis direction of the first part 361A toward the negative side in the X-axis direction. As viewed from the positive side in the X-axis direction, both ends in the Z-axis direction of the first part 361A are linear, and an end on the negative side in the Y-axis direction is semicircular. As viewed from the negative side in the X-axis direction, both ends in the Y-axis direction of the second part 361B are linear, and an end on the positive side in the Z-axis direction is semicircular. In other words, as viewed in the X-axis direction, the second part 361B is semicircular. As viewed in the Y-axis direction, an end on the negative side in the X-axis direction of the second part 361B is linear, and an end on the positive side in the X-axis direction is semicircular. In other words, as viewed in the Y-axis direction, the first part 361A is semicircular. The first liquid passage part 361 (second part 361B) includes a surface 381 approximately in parallel with a YZ plane at an end on the negative side in the X-axis direction. The second liquid passage part 362 includes a first part 362A and a second part 362B. The first part 362A extends from an end on the negative side in the X-axis direction of the large-diameter part 33 toward the negative side in the Y-axis direction. The second part 362B extends from an end on the negative side in the Y-axis direction of the first part 362A in the X-axis direction. As viewed in the X-axis direction, both ends in the Z-axis direction of the first part 362A are linear, and an end on the negative side in the Y-axis direction is semicircular. In other words, as viewed in the X-axis direction, the second part 362B is semicircular. As viewed from the Y-axis direction, both ends in the X-axis direction of the second part 362B are linear. The second liquid passage part 362 (second part 362B) includes a surface 382 approximately in parallel with the YZ plane at an end on the negative side in the X-axis direction.

The first flange part 351 extends from ends on the negative side in the X-axis direction of the small-diameter part 31 and the intermediate part 32 toward the negative side in the X-axis direction and the negative side in the Y-axis direction. As viewed in the X-axis direction, an end on the negative side in the Y-axis direction of the first flange part 351 is linear. As viewed in the Y-axis direction, both ends in the X-axis direction of the first flange part 351 are linear. The first flange part 351 includes a surface 383 and a surface 384. The surface 383 is formed at an end on the negative side in the X-axis direction of the first flange part 351, and is approximately in parallel with the YZ plane. The surface 384 is formed at an end on the positive side in the X-axis direction of the first flange part 351, and is approximately in parallel with the YZ plane. A bolt hole 391 extending in the X-axis direction passes through at an approximate center in the Z-axis direction of the first flange part 351. The bolt hole 391 opens on the surfaces 383 and 384. The second flange part 352 extends from an end on the negative side in the X-axis direction between the large-diameter part 33 and the end 34 toward the negative side in the Y-axis direction. As viewed in the X-axis direction, the second flange part 352 (an end on the negative side in the Y-axis direction) is semicircular. As viewed in the Y-axis direction, the both ends in the X-axis direction of the first flange part 351 are linear. The second flange part 352 includes a surface 385 and a surface 386. The surface 385 is formed at an end on the negative side in the X-axis direction of the second flange part 352, and is approximately in parallel with the YZ plane. The surface 386 is formed at an end on the positive side in the X-axis direction of the second flange part 352, and is approximately in parallel with the YZ plane. A bolt hole 392 extending in the X-axis direction with the center of the semicircle as an axial center passes through the second flange part 352. The bolt hole 392 opens on the surfaces 385 and 386. The bleeder parts 371 and 372 each have a tubular shape. The first bleeder part 371 extends from an end on the negative side in the X-axis direction of the small-diameter part 31, and approximately the same position in the Z-axis direction as the first liquid passage part 361 (end on the positive side in the Z-axis direction of the small-diameter part 31) toward the positive side in the Y-axis direction. The second bleeder part 372 extends from an end on the negative side in the X-axis direction of the large-diameter part 33, and approximately the same position in the Z-axis direction as the second liquid passage part 362 (end on the positive side in the Z-axis direction of the large-diameter part 33) toward the positive side in the Y-axis direction. An end on the positive side in the Y-axis direction of each of the bleeder parts 371 and 372 is approximately in parallel with the XZ plane, and is arranged between an end on the positive side in the Y-axis direction of the large-diameter part 33 and an end on the positive side in the Y-axis direction of the end 34. Outer diameters of the bleeder parts 371 and 372, and diameters of the semicircles of the first part 361A, the second parts 361B and 362B, and the second flange part 352, which are semicircular, are approximately the same.

The first flange part 351, the first liquid passage part 361, and the second liquid passage part 362 integrally continue to one another. An end on the positive side in the Z-axis direction of the first flange part 351 continues to the first liquid passage part 361. An end on the negative side in the Z-axis direction of the first flange 351 continues to the second liquid passage part 362. An end on the negative side in the Y-axis direction of the first liquid passage part 361 approximately matches an end on the negative side in the Y-axis direction of the first flange part 351. An end on the negative side in the Y-axis direction of the second liquid passage part 362 is slightly on the negative side in the Y-axis direction with respect to an end on the negative side in the Y-axis direction of the first flange part 351, and approximately matches an end on the negative side in the Y-axis direction of the second flange part 352. Ends on the negative side in the X-axis direction of the first flange part 351, the first liquid passage part 361, and the second liquid passage part 362 approximately match one another. In other words, the surfaces 381, 382, and 383 are on approximately the same planes. The surfaces 381, 382, and 383 are positioned slightly on the negative side in the X-axis direction (at an end on the negative side in the X-axis direction of the end 34) with respect to an end on the negative side in the X-axis direction of the large-diameter part 33. Ends on the positive side in the X-axis direction of the first flange part 351 and the second flange part 352 approximately match each other. In other words, the surfaces 384 and 386 are on approximately the same planes. An end on the positive side in the X-axis direction of the first liquid passage part 361 is slightly on the positive side in the X-axis direction with respect to an end on the positive side in the X-axis direction of the first flange part 351. An end on the positive side in the X-axis direction of the second liquid passage part 362 is on the positive side in the X-axis direction with respect to an end on the positive side in the X-axis direction of the first liquid passage part 361, and is slightly on the negative side in the X-axis direction with respect to an end on the positive side in the X-axis direction of the large-diameter part 33.

A cylinder 30, a plurality of liquid passages, and a plurality of ports are formed inside the housing 3. The cylinder 30 has a bottomed tubular shape extending in the Z-axis direction, is closed on the positive side in the Z-axis direction (a side of the small-diameter part 31), and is open on the negative side in the Z-axis direction (a side of the end 34). The cylinder 30 includes a small-diameter part 301 and a large-diameter part 302. The small-diameter part 301 is formed on the positive side in the Z-axis direction (on an inner peripheral side of the small-diameter part 31). The large-diameter part 302 is formed on the negative side in the Z-axis direction (on an inner peripheral side of the large-diameter part 33). A first seal groove 303A is formed at an approximate center in the Z-axis direction of the small-diameter part 301, and a second seal groove 303B is formed on the negative side in the Z-axis direction. Each of the seal grooves 303 has an annular shape extending in a circumferential direction about an axial center of the cylinder 30. The plurality of liquid passages include a first connection liquid passage 304 and a second connection liquid passage 305 serving as simulator connection liquid passages, a first bleeder liquid passage 307A, and a second bleeder liquid passage 307B. The plurality of ports include a first simulator connection port 306A and a second simulator connection port 306B serving as simulator connection ports, a first bleeder port 308A, and a second bleeder port 308B.

The first simulator connection port 306A has a tubular shape extending in the X-axis direction inside the second part 361B, and opens on the surface 381. The first connection liquid passage 304 includes a first part 304A and a second part 304B. The first part 304A has one end connected to (open on) a portion on the positive side in the Z-axis direction, the negative side in the X-axis direction, and the negative side in the Y-axis direction of the small-diameter part 301, and extends from the one end toward the negative side in the Y-axis direction through an inside of the first liquid passage part 361 (the first part 361A). The first part 304A extends on a center of the semicircle of the first part 361A which is semicircular as viewed in the Y-axis direction. The second part 304B has one end connected to an end on the negative side in the Y-axis direction of the first part 304A, and extends from the one end toward the negative side in the X-axis direction through an inside of the second part 361B (while being bent at an approximate right angle with respect to the first part 304A), and an end on the negative side in the X-axis direction of the second part 304B is connected to (opens on) the port 306A. The second part 304B and the port 306A extend on a center of the semicircle of the second part 361B which is semicircular as viewed in the X-axis direction. The second simulator connection port 306B has a tubular shape extending in the X-axis direction inside the second part 362B, and opens on the surface 382. The second connection liquid passage 305 includes a first part 305A and a second part 305B. The first part 305A has one end connected to (open on) a portion on the positive side in the Z-axis direction, the negative side in the X-axis direction, and the negative side in the Y-axis direction of the large-diameter part 302, and extends from the one end toward the negative side in the Y-axis direction through an inside of the second liquid passage part 362 (the first part 362A). The second part 305B has one end connected to an end on the negative side in the Y-axis direction of the first part 305A, and extends from the one end toward the negative side in the X-axis direction through an inside of the second part 362B (while being bent at an approximate right angle with respect to the first part 305A), and an end on the negative side in the X-axis direction of the second part 305B is connected to (opens on) the port 306B. The second part 305B and the port 306B extend on a center of the semicircle of the second part 362B which is semicircular as viewed in the X-axis direction.

The first bleeder port 308A has a tubular shape extending on an axial center of the first bleeder part 371 in the Y-axis direction, and opens on an end surface on the positive side in the Y-axis direction of the first bleeder part 371. The second bleeder port 308B has a tubular shape extending on an axial center of the second bleeder part 372 in the Y-axis direction, and opens on an end surface on the positive side in the Y-axis direction of the second bleeder part 372. A bleeder valve BV is mounted to each of the bleeder ports 308A and 308B. The first bleeder liquid passage 307A extends on an axial center of the first bleeder part 371 in the Y-axis direction. One end of the first bleeder liquid passage 307A is connected to (open on) a portion on the positive side in the Z-axis direction, the negative side in the X-axis direction, and the positive side in the Y-axis direction of the small-diameter part 301, and the other end is connected to (opens on) the first bleeder port 308A. The first bleeder liquid passage 307A extends on approximately the same straight line as the first part 304A of the first connection liquid passage 304. The second bleeder liquid passage 307B extends on an axial center of the second bleeder part 372 in the Y-axis direction. One end of the second bleeder liquid passage 307B is connected to (open on) a portion on the positive side in the Z-axis direction, the negative side in the X-axis direction, and the positive side in the Y-axis direction of the large-diameter part 302, and the other end is connected to (opens on) the second bleeder port 308B. The second bleeder liquid passage 307B extends on approximately the same straight line as the first part 305A of the second connection liquid passage 305.

The stroke simulator 4 includes a piston 41, a first seal member 421, a second seal member 422, a first spring 431, a second spring 432, a first retainer member 44A, a second retainer member 44B, a stopper member 45, a seat member 46, a first damper 471, a second damper 472, and a plug member 48. The piston 41 has a bottomed tubular shape, and is accommodated in the cylinder 30. The piston 41 includes a first recessed part 411 and a second recessed part 412. The first recessed part 411 opens to the positive side in the Z-axis direction, and the second recessed part 412 opens to the negative side in the Z-axis direction. The recessed parts 411 and 412 are partitioned from each other by a wall part 410. A protruded part 413 having a cylindrical shape protrudes from the wall part 410 inside the second recessed part 412. The piston 41 is movable in the Z-axis direction along an inner peripheral surface of the small-diameter part 301. An inside of the cylinder 30 is partitioned into two chambers separated from each other by the piston 41. A positive-pressure chamber (main chamber) 401 serving as a first chamber is defined between a positive side in the Z-axis direction (including an inner peripheral side of the first recessed part 411) of the piston 41 and the small-diameter part 301. A back-pressure chamber (sub chamber) 402 serving as a second chamber is defined between a negative side in the Z-axis direction of the piston 41 and the large-diameter part 302. The first connection liquid passage 304 always opens in the positive-pressure chamber 401. The second connection liquid passage 305 always opens in the back-pressure chamber 402. First and second seal members 421 and 422 are provided in the first and second seal grooves 303A and 303B, respectively. The seal members 421 and 422 each have a cup shape, and a lip part of each of the seal members 421 and 422 is held in slide contact with an outer peripheral surface of the piston 41. The first seal member 421 is configured to suppress a flow of the brake fluid from the positive side in the Z-axis direction (positive-pressure chamber 401) toward the negative side in the Z-axis direction (back-pressure chamber 402). The second seal member 422 is configured to suppress a flow of the brake fluid from the negative side in the Z-axis direction (back-pressure chamber 402) toward the positive side in the Z-axis direction (positive-pressure chamber 401). The positive-pressure chamber 401 and the back-pressure chamber 402 are separated from each other in a liquid-tight manner by the seal members 421 and 422. Each of the seal members 421 and 422 may be an X ring, or two seal members each having a cup shape may be arranged side by side so as to be capable of suppressing the flows of the brake fluid to both the positive-pressure chamber 401 and the back-pressure chamber 402. Further, as a structure for providing the seal members 421 and 422, in this embodiment, the seal grooves 303A and 303B are formed in the cylinder 30 (so-called rod seals are provided), but seal grooves may alternatively be provided on the piston 41 (so-called piston seals may be provided).

The springs 431 and 432, the retainer member 44, the stopper member 45, the seat member 46, and the dampers 471 and 472 are accommodated in the back-pressure chamber 402. The first spring 431, the retainer member 44, and the stopper member 45 form a single spring unit. The springs 431 and 432 are coil springs serving as elastic members. The first spring 431 has a small diameter. The second spring 432 has a large diameter, and has a larger spring constant than the first spring 431. The retainer member 44 includes a tubular part 440. A first flange part 441 extends to a radially outer side on one end side in an axial direction of the tubular part 440, and a second flange part 442 extends to a radially inner side on the other end side in the axial direction of the tubular part 440. The first spring 431 is provided in a compressed state between (the first flange part 441 of) the first retainer member 44A and (the first flange part 441 of) the second retainer member 44B. The stopper member 45 has a bolt shape including a shaft part 450, and a head part 451 extends to a radially outer side at one end of the shaft part 450. The other end of the shaft part 450 is fixed to the second flange part 442 of the second retainer member 44B. The head part 451 is accommodated in an inner peripheral side of the tubular part 440 of the first retainer member 44A so as to be movable along the inner peripheral surface of the tubular part 440. The first spring 431 is extended to a maximum length under a state in which the heat part 451 is held in abutment against the second flange part 442.

The seat member 46 has a bottomed tubular shape including a tubular part 460 and a bottom part 461. A flange part 462 extends to a radially outer side on an opening side of the tubular part 460. The first damper 471 is an elastic member made of rubber or the like, and has a cylindrical shape. The second damper 472 is an elastic member made of rubber or the like, and has a cylindrical shape having a narrowed portion at a center in the axial direction. The plug member 48 is fixed to the end 34, and closes the opening of the cylinder 30 (large-diameter part 302) in a liquid-tight manner. A first recessed part 481 having a bottomed tubular shape is formed on the positive side in the Z-axis direction of the plug member 48, and a second recessed part 482 having a bottomed annular shape is formed so as to surround the first recessed part 481. The second damper 472 is provided in the first recessed part 481. The unit of the first spring 431 is provided between the piston 41 and the seat member 46. The first flange part 441 of the first retainer member 44A is provided on the partition wall 410 of the piston 41. A positive side in the Z-axis direction of the tubular part 440 of the first retainer member 44A is fitted to the protruded part 413. The first damper 471 is provided so as to be held in abutment against the protruded part 413 on an inner peripheral side of the tubular part 440. The second retainer member 44B is provided on an inner peripheral side of the seat member 46 (tubular part 460), and the flange part 441 is held in abutment against the bottom part 461. The second spring 432 is provided between the seat member 46 and the plug member 48. The positive side in the Z-axis direction of the second spring 432 is fitted to the tubular part 460 of the seat member 46, and is held by the seat member 46. A negative side in the Z-axis direction of the second spring 432 is accommodated in the second recessed part 482 of the plug member 48, and is held by the plug member 48. The second spring 432 is provided in a compressed state between the flange part 462 of the seat member 46 and the plug member 48 (the bottom part of the second recessed part 482). Each of the first and second springs 431 and 432 functions as a return spring configured to always bias the piston 41 toward the positive-pressure chamber 401 side (a direction of decreasing a volume of the positive-pressure chamber 401, and increasing a volume of the back-pressure chamber 402).

Next, description is given of a configuration of the second unit 1B. The second unit 1B is a hydraulic pressure unit configured to generate a hydraulic pressure in the wheel cylinders W/C via the liquid passages. The second unit 1B includes a housing 5, a motor 20, a pump 2, a plurality of electromagnetic valves 21 and the like, a plurality of hydraulic pressure sensors 91 and the like, and an electronic control unit (control unit, hereinafter referred to as “ECU”) 90. The housing 5 is configured to internally accommodate (build in) the pump 2, valve bodies of the electromagnetic valves 21 and the like. Circuits (brake hydraulic pressure circuits) in the P system and the S system through which the brake fluid flows are formed of a plurality of liquid passages 11 and the like inside the housing 5. Moreover, a plurality of ports 51 are formed inside the housing 5, and these ports 51 open on outer surfaces of the housing 5. The liquid passages 11 and the like and the ports 51 are formed by machining with drills and the like. The plurality of ports 51 continue to the liquid passages 11 and the like inside the housing 5, to thereby connect the liquid passages 11 and the like and the liquid passages (pipe 10M and the like) outside the housing 5 to each other. The liquid passages 11 and the like include the supply liquid passages 11, a suction liquid passage 12, discharge liquid passages 13, a pressure-regulating liquid passage 14, pressure-reducing liquid passages 15, a positive-pressure liquid passage 16, a back-pressure liquid passage 17, a first simulator liquid passage 18, and a second simulator liquid passage 19.

The plurality of ports 51 include master cylinder ports 511 (a primary port 511P and a secondary port 511S), wheel cylinder ports 512, a suction port 513, a first unit connection port (positive-pressure port) 514, and a second unit connection port (back pressure port) 515. The master cylinder ports 511 are connected to the supply liquid passages 11, and connect the housing 5 (second unit 1B) to the master cylinder 7 (hydraulic pressure chamber 70) via the master cylinder pipes 10M. The ports 511 are master cylinder connection ports. One end of the primary pipe 10MP is connected to the primary port 511P. One end of the secondary pipe 10MS is connected to the secondary port 511S. The wheel cylinder ports 512 are connected to the supply liquid passages 11, and connect the housing 5 (second unit 1B) to the wheel cylinders W/C via the wheel cylinder pipe 10W. The ports 512 are wheel cylinder connection ports. One end of the wheel cylinder pipe 10W is connected to the port 512. The suction port 513 is connected to the first liquid reservoir chamber 521 inside the housing 5, and connects the housing 5 to the reservoir tank 8 (second chamber 83R) via the suction pipe 10R. A nipple 10R2 is fixedly provided in the suction port 513, and one end of the suction pipe 10R is connected to the nipple 10R2. The first unit connection port 514 is connected to the positive-pressure liquid passage 16, and connects the housing 5 to the stroke simulator 4 (positive-pressure chamber 401). A first simulator connection port 306A of the first unit 1A is connected to the port 514. The second unit connection port 515 is connected to the back-pressure liquid passage 17, and connects the housing 5 to the stroke simulator 4 (back-pressure chamber 402). A second simulator connection port 306B of the first unit 1A is connected to the port 515.

The motor 20 is an electric motor of a rotation type, and includes a rotation shaft for driving the pump 2. The motor 20 may be a brush motor or a brushless motor including a resolver configured to detect the rotation angle or the number of revolutions of the above-mentioned rotation shaft. The pump 2 is a first hydraulic pressure source capable of supplying an operation hydraulic pressure to the wheel cylinders W/C, and includes a plurality of (five) pump parts 2A to 2E driven by the single motor 20. The pump 2 is a radial plunger pump of a fixed cylinder type, and is used for the S system and the P system in common. Each of the electromagnetic valves 21 and the like is an actuator configured to operate in accordance with a control signal, and includes a solenoid and a valve body. The valve body is configured to perform a stroke in accordance with a current supply to the solenoid to switch opening and closing of a flow passage 11 and the like (open/close the flow passage 11 and the like). Each of the electromagnetic valves 21 and the like controls the communication state of the circuit and adjusts the flow state of the brake fluid to generate a control hydraulic pressure. The electromagnetic valves 21 and the like include shutoff valves 21, pressure-boosting valves (hereinafter referred to as “SOL/V IN”) 22, communication valves 23, a pressure-regulating valve 24, pressure-reducing valves (hereinafter referred to as “SOL/V OUT”) 25, a stroke simulator-in valve (hereinafter referred to as “SS/V IN”) 28, and a stroke simulator-out valve (hereinafter referred to as “SS/V OUT”) 29. Each of the valves 21, 22, and 24 is a normally-open valve, which is opened in a non-current supply state. Each of the valves 23, 25, 28, and 29 is a normally-closed valve, which is closed in the non-current supply state. Each of the valves 21, 22, and 24 is a proportional control valve which has an opening degree adjusted in accordance with the current supplied to the solenoid. Each of the valves 23, 25, 28, and 29 is an ON/OFF valve which is subjected to binary switching control between an opening state and a closing state. A proportional control valve may be used for each of those valves 23, 25, 28, and 29. Each of the hydraulic pressure sensor 91 and the like is configured to detect a discharge pressure of the pump 2 or a master cylinder pressure. The hydraulic pressure sensor 91 and the like include a master cylinder pressure sensor 91, wheel cylinder pressure sensors 92 (primary pressure sensor 92P and secondary pressure sensor 92S), and a discharge pressure sensor 93.

Now, based on FIG. 2, description is given of the brake hydraulic pressure circuit of the second unit 1B. For members corresponding to the wheels W(FL), W(FR), W(RL), and W(RR), suffixes of “a” to “d” are added to respective reference numerals for proper distinction. One end side of a supply liquid passage 11P is connected to the primary port 511P. The other end side of the liquid passage 11P is branched into a liquid passage 11a for the front left wheel and a liquid passage 11d for the rear right wheel. One end side of a liquid passage 11S is connected to the secondary port 511S. The other end side of the liquid passage 11S is branched into a liquid passage 11b for the front right wheel and a liquid passage 11c for the rear left wheel. The liquid passages 11a to 11d are connected to the corresponding wheel cylinder ports 512a to 512d, respectively. The shutoff valve 21 is provided on the one end side of each of the liquid passages 11. The SOL/V IN 22 is provided in each of the liquid passages 11a to 11d. A bypass liquid passage 110 bypassing the SOL/V IN 22 is provided in parallel with each of the liquid passages 11. A check valve 220 is provided in the liquid passage 110. The valve 220 permits only a flow of the brake fluid from the wheel cylinder port 512 side to the master cylinder port 511 side. The positive-pressure liquid passage 16 branches from between the secondary port 511S and the shutoff valve 21S in the liquid passage 11S. One end side of the positive-pressure liquid passage 16 is connected to the liquid passage 11S. The other end side of the positive-pressure liquid passage 16 is connected to the positive-pressure port 514.

The suction liquid passage 12 connects the first liquid reservoir chamber 521 and suction port of the pump 2 to each other. One end side of the discharge liquid passage 13 is connected to a discharge part of the pump 2. The other end side of the discharge liquid passage 13 is branched into the liquid passage 13P for the P system and the liquid passage 13S for the S system. Each of the liquid passages 13P and 13S is connected to a part between the shutoff valve 21 and the SOL/V IN 22 in the supply liquid passage 11. The communication valve 23 is provided in each of the liquid passages 13P and 13S. The liquid passages 13P and 13S function as communication passages for connecting the supply liquid passage 11P in the P system and the supply liquid passage 11S in the S system to each other. The pump 2 is connected to the wheel cylinder ports 512 via the communication passages (discharge liquid passages 13P and 13S) and the supply liquid passages 11P and 11S. The pressure-regulating liquid passage 14 connects an intermediate portion of the discharge liquid passages 13 between the pump 2 and the communication valves 23, and the first liquid reservoir chamber 521 to each other. The pressure-regulating valve 24 serving as a first pressure-reducing valve is provided in the liquid passage 14. The pressure-reducing liquid passage 15 connects an intermediate portion between the SOL/V IN 22 in each of the liquid passages 11a to 11d and the wheel cylinder port 512, and the first liquid reservoir chamber 521 to each other. The SOL/V OUT 25 serving as a second pressure-reducing valve is provided in the liquid passage 15.

One end side of the back pressure liquid passage 17 is connected to the back pressure port 515. The other end side of the liquid passage 17 is branched into a first simulator liquid passage 18 and a second simulator liquid passage 19. The first simulator liquid passage 18 is connected to parts between the shutoff valve 21S and the SOL/V INs 22b and 22c in the supply liquid passage 11S. The SS/V IN 28 is provided in the liquid passage 18. A bypass liquid passage 180 bypassing the SS/V IN 28 is provided in parallel with the liquid passage 18. A check valve 280 is provided in the bypass liquid passage 180. The valve 280 permits only a flow of the brake fluid from the back pressure liquid passage 17 side to the supply liquid passage 11S side. The second simulator liquid passage 19 is connected to the first liquid reservoir chamber 521. The SS/V OUT 29 is provided in the liquid passage 19. A bypass liquid passage 190 bypassing the SS/V OUT 29 is provided in parallel with the liquid passage 19. A check valve 290 is provided in the liquid passage 190. The valve 290 permits only a flow of the brake fluid from the first liquid reservoir chamber 521 side to the back pressure liquid passage 17 side. The hydraulic pressure sensor 91 is provided between the shutoff valve 21S and the secondary port 511S in the supply liquid passage 11S. The hydraulic pressure sensor 91 is configured to detect a hydraulic pressure (hydraulic pressure in the positive-pressure chamber 401 of the stroke simulator 4, or the master cylinder pressure) at this position. The hydraulic pressure sensor 92 is provided between the shutoff valve 21 and the SOL/V INs 22 in the supply liquid passage 11. The hydraulic pressure sensor 92 is configured to detect a hydraulic pressure (corresponding to the wheel cylinder hydraulic pressure) at this position. The hydraulic pressure sensor 93 is provided between the pump 2 and the communication valves 23 in the discharge liquid passage 13. The hydraulic pressure sensor 93 is configured to detect a hydraulic pressure (pump discharge pressure) at this position.

The housing 5 of the second unit 1B is a block having a generally rectangular parallelepiped shape and made of aluminum alloy as a material. Outer surfaces of the housing 5 include a front surface 501, a rear surface 502, a bottom surface 503, a top surface 504, a left side surface 505, and a right side surface 506. The front surface 501 is a flat surface having a relatively large area. The rear surface 502 is a flat surface approximately parallel with the front surface 501, and opposes the front surface 501 (across the housing 5). The bottom surface 503 is a flat surface continuing to the front surface 501 and the rear surface 502. The top surface 504 is a flat surface approximately parallel with the bottom surface 503, and opposes the bottom surface 503 (across the housing 5). The left side surface 505 is a flat surface continuing to the front surface 501, the rear surface 502, the bottom surface 503, and the top surface 504. The right side surface 506 is a flat surface approximately in parallel with the left side surface 505, and opposes the left side surface 505 (across the housing 5). The right side surface 506 continues to the front surface 501, the rear surface 502, the bottom surface 503, and the top surface 504. Under a state in which the housing 5 is mounted to a vehicle, the front surface 501 is arranged on the positive side in the Y-axis direction, and extends approximately in parallel with the XZ plane. The rear surface 502 is arranged on the negative side in the Y-axis direction, and extends approximately in parallel with the XZ plane. The top surface 504 is arranged on the positive side in the Z-axis direction, and extends approximately in parallel with an XY plane. The bottom surface 503 is arranged on the negative side in the Z-axis direction, and extends approximately in parallel with the XY plane. The right side surface 506 is arranged on the positive side in the X-axis direction, and extends approximately in parallel with a YZ plane. The left side surface 505 is arranged on the negative side in the X-axis direction, and extends approximately in parallel with the YZ plane. In actual use, arrangement of the housing 5 on the XY plane is not restricted in any way, and the housing 5 may be arranged on the XY plane at any position and in any orientation in accordance with a vehicle layout and the like.

Recessed parts 50 are formed at corners between the front surface 501 and the top surface 504 in the housing 5. In other words, a corner formed of the front surface 501, the top surface 504, and the right side surface 506 and a corner formed of the front surface 501, the top surface 504, and the left side surface 505 have cutoff shapes, and thus have a first recessed part 50A and a second recessed part 50B. The first recessed part 50A is left open (opens) on the front surface 501, the top surface 504, and the left side surface 505. The second recessed part 50B is left open (opens) on the front surface 501, the top surface 504, and the right side surface 506. The first recessed part 50A includes a first flat surface part 507, a second flat surface part 508, and a third flat surface part 509. The first flat surface part 507 is approximately orthogonal to the Y axis, and is approximately in parallel with the XZ plane. The second flat surface part 508 is approximately orthogonal to the X axis, and is approximately in parallel with the YZ plane. The third flat surface part 509 extends in the Y-axis direction, and forms an angle of approximately 50 degrees in a counterclockwise direction with respect to the right side surface 506 as viewed from the positive side in the Y-axis direction. The second flat surface part 508 and the third flat surface part 509 smoothly continue to each other via a recessed curved surface extending in the Y-axis direction. A configuration of the second recessed part 50B is the same as that of the first recessed part 50A. The first recessed part 50A and the second recessed part 50B are approximately symmetrical with respect to the YZ plane at a center in the X-axis direction of the housing 5. The housing 5 internally includes the first liquid reservoir chamber 521, the second liquid reservoir chamber 522, a cam accommodating hole, a plurality of (five) cylinder accommodating holes 53A to 53E, a plurality of valve accommodating holes 54, a plurality of sensor accommodating holes, a power supply hole 55, and a plurality of fixing holes 56. These holes and chambers are also formed by drills and the like.

The first liquid reservoir chamber 521 has a bottomed tubular shape extending in the Z-axis direction, opens at an approximate center in the X-axis direction and on the positive side in the Y-axis direction on the top surface 504, and is arranged so as to extend from the top surface 504 toward the inside of the housing 5. The second liquid reservoir chamber 522 has a bottomed tubular shape, which has an axial center extending in the Z-axis direction, opens on the negative side in the X-axis direction and on the positive side in the Y-axis direction on the bottom surface 503, and is arranged so as to extend from the bottom surface 503 toward the inside of the housing 5. The cam accommodating hole has a bottomed tubular shape extending in the Y-axis direction, and is opened on the front surface 501. An axial center O of the cam accommodating hole is approximately at a center in the X-axis direction on the front surface 501, and is arranged slightly on the negative side in the Z-axis direction with respect to a center in the Z-axis direction. The cylinder accommodating hole 53 has a stepped tubular shape, and has an axial center extending in a radial direction (radiation direction about the axial center O) of the cam accommodating hole. Parts of the holes 53A to 53E on closer sides to the cam accommodating hole (axial center O) function as suction parts of the pump parts 2A to 2E, respectively, and are connected to one another via a first communication liquid passage. Parts of the holes 53A to 53E on farther sides from the cam accommodating hole function as discharge parts of the pump parts 2A to 2E, respectively, and are connected to one another via a second communication liquid passage. The plurality of holes 53A to 53E are arranged approximately evenly (at approximately equal intervals) in a circumferential direction about the axial center O. The holes 53A to 53E are arrayed in a single row along the Y-axis direction, and are arranged on the positive side in the Y-axis direction of the housing 5. In other words, axial centers of the holes 53A to 53E are approximately on the same plane which is approximately orthogonal to the axial center O. This plane is approximately in parallel with the front surface 501 and the rear surface 502, and is closer to the front surface 501 than the rear surface 502.

The respective holes 53A to 53E are arranged inside the housing 5 as follows. The hole 53A extends from the bottom surface 503 toward the positive side in the Z-axis direction. The hole 53B extends from the negative side in the Z-axis direction with respect to the axial center O on the left side surface 505 toward the positive side in the X-axis direction and the positive side in the Z-axis direction. The hole 53C extends from the first recessed part 50A toward the positive side in the X-axis direction and the negative side in the Z-axis direction. The hole 53D extends from the second recessed part 50B toward the negative side in the X-axis direction and the negative side in the Z-axis direction. The hole 53E extends from the negative side in the Z-axis direction with respect to the axial center O on the right side surface 506 toward the negative side in the X-axis direction and the positive side in the Z-axis direction. On the negative side in the Z-axis direction with respect to the axial center O, the hole 53A is at approximately the same position as the axial center O in the X-axis direction, and the holes 53B and 53E are arranged on both sides of the axial center O (hole 53A) in the X-axis direction. On the positive side in the Z-axis direction with respect to the axial center O, the holes 53C and 53D are arranged on both sides of the axial center O in the X-axis direction. One end of each of the holes 53A to 53E opens on an inner peripheral surface of the cam accommodating hole. The other end of the hole 53A opens at an approximate center in the X-axis direction and on the positive side in the Y-axis direction on the bottom surface 503. The other end of the hole 53B opens on the positive side in the Y-axis direction and on the negative side in the Z-axis direction on the left side surface 505. The other end of the hole 53E opens on the positive side in the Y-axis direction and on the negative side in the Z-axis direction on the right side surface 506. The other ends of the holes 53C and 53D open in the first and second recessed parts 50A and 50B, respectively. Specifically, more than half of the other end of each of the holes 53C and 53D opens on the third flat surface part 509, and the rest opens on the second flat surface part 508. The first liquid reservoir chamber 521 is formed in a region on the positive side in the Z-axis direction with respect to the cam accommodating hole, and between the holes 53C and 53D in the circumferential direction about the axial center O. The chamber 521 and the holes 53C and 53D partially overlap each other in the Y-axis direction (as viewed in the X-axis direction). The second liquid reservoir chamber 522 is formed in a region on the negative side in the Z-axis direction with respect to the cam accommodating hole O, and between the holes 53A and 53B in the circumferential direction about the axial center O. The cam accommodating hole and the second liquid reservoir chamber 522 are connected to each other via a drain liquid passage.

A rotational drive shaft, which is a rotation shaft and a drive shaft of the pump 2, and a cam unit 2U are accommodated in the cam accommodating hole. The rotational drive shaft is coupled and fixed to the rotation shaft of the motor 20 so that the axial center thereof extends on an extension of the axial center of the rotation shaft of the motor 20, and is rotationally driven by the motor 20. The cam unit 2U is provided on the rotational drive shaft. Each of the pump parts 2A to 2E is a plunger pump (piston pump) as a reciprocal pump operating through the rotation of the rotational drive shaft, and is configured to suck and discharge the brake fluid serving as working fluid as a result of a reciprocal motion of the plunger (piston). The cam unit 2U is configured to convert the rotational motion of the rotational drive shaft to the reciprocal motion of the plunger. The plungers are arranged around the cam unit 2U, and are accommodated in the cylinder accommodating holes 53, respectively. An axial center of the plunger approximately matches an axial center of the cylinder accommodating hole 53, and extends in the radial direction of the rotational drive shaft. In other words, the number of the plungers is equal to the number (five) of the cylinder accommodating holes 53, and the plungers extend in the radial directions with respect to the axial center O. These plungers are driven by the same rotational drive shaft and the same cam unit 2U. The brake fluid discharged by the respective pump parts 2A to 2E to the second communication liquid passage is collected to the single discharge liquid passage 13, and is used in common by the two systems of the hydraulic pressure circuit.

Each of the plurality of the valve accommodating holes 54 has a bottomed tubular shape, extends in the Y-axis direction, and opens on the rear surface 502. The plurality of valve accommodating holes 54 are arrayed in a single row along the Y-axis direction, and are arranged on the negative side in the Y-axis direction of the housing 5. The cylinder accommodating holes 53 and the valve accommodating holes 54 are arranged along the Y-axis direction. The valve accommodating holes 54 at least partially overlap the cylinder accommodating holes 53 as viewed in the Y-axis direction. A valve part of the electromagnetic valve 21 or the like is fitted to each of the valve accommodating holes 54, and a valve body is accommodated in each of the valve accommodating holes 54. Each of a plurality of sensor accommodating holes has a bottomed tubular shape, which has an axial center extending in the Y-axis direction, and opens on the rear surface 502. A pressure sensitive part of the liquid pressure sensor 91 or the like is accommodated in each of the sensor accommodating holes. The power supply hole 55 has a tubular shape, and passes through the housing 5 (between the front surface 501 and the rear surface 502) in the Y-axis direction. The hole 55 is arranged at an approximate center in the X-axis direction and on the positive side in the Z-axis direction of the housing 5. The hole 55 is formed in a region between the cylinder accommodating holes 53C and 53D.

Each of the master cylinder ports 511 has a bottomed tubular shape, which has an axial center extending in the Y-axis direction, and is opened in a portion at an end on the positive side in the Z-axis direction between the recessed parts 50A and 50B on the front surface 501. A primary port 511P is formed on the positive side in the X-axis direction. The secondary port 511S is formed on the negative side in the X-axis direction. Both the ports 511P and 511S are arrayed in the X-axis direction, and are on both sides of the first liquid reservoir chamber 521 in the X-axis direction (as viewed in the Y-axis direction). The ports 511P and 511S are formed between the first liquid reservoir chamber 521 and the cylinder accommodating holes 53C and 53D in the circumferential direction of the axial center O (as viewed in the Y-axis direction), respectively. Each of the wheel cylinder ports 512 has a bottomed tubular shape, which has an axial center extending in the Z-axis direction, and is opened on the negative side in the Y-axis direction (position closer to the rear surface 502 than to the front surface 501) in the top surface 504. The ports 512a to 512d are arrayed in a single row in the X-axis direction. The ports 512a and 512d in the P system are formed on the positive side in the X-axis direction. The ports 512b and 512c in the S system are formed on the negative side in the X-axis direction. The port 512a is formed on the positive side in the X-axis direction with respect to the port 512d. The port 512b is formed on the negative side in the X-axis direction with respect to the port 512c. The ports 512c and 512d are on both sides of the suction port 513 (first liquid reservoir chamber 521) as viewed in the Y-axis direction. The ports 512 and the first liquid reservoir chamber 521 partially overlap each other in the Z-axis direction. The first liquid reservoir chamber 521 is arranged in a region surrounded by the master cylinder ports 511P and 511S and the wheel cylinder ports 512c and 512d. The suction port 513 (first reservoir chamber 521) is arranged inside a quadrangle formed by connecting (centers of) the ports 511P, 5111S, 512c, and 512d to each other with line segments, as viewed in the Z-axis direction. The suction port 513 is the opening of the first liquid reservoir chamber 521 on the top surface 504, and is opened to the top side in the vertical direction. The port 513 is opened on a center side in the X-axis direction and close to the positive side in the Y-axis direction (closer to the front surface 501 than the wheel cylinder ports 512) on the top surface 504. The port 513 is formed on the positive side in the Z-axis direction with respect to the suction parts of the pump parts 2A to 2E. The cylinder accommodating holes 53C and 53D are on both sides of the port 513 as viewed in the Y-axis direction. An opening of each of the cylinder accommodating holes 53C and 53D and the port 513 partially overlap each other in the Y-axis direction (as viewed in the X-axis direction). The unit first connection port 514 has a bottomed tubular shape, which has an axial center extending in the X-axis direction, and is opened slightly on the negative side in the Y-axis direction with respect to the center in the Y-axis direction and on the positive side in the Z-axis direction of the right side surface 506. The port 514 opens slightly on the negative side in the Z-axis direction with respect to the master cylinder ports 511, and opens adjacently to a negative side in the Y-axis direction of the second recessed part 50B (first flat surface part 507). The second unit connection port 515 has a bottomed tubular shape, which has an axial center extending in the X-axis direction, and opens slightly on the negative side in the Y-axis direction with respect to the center in the Y-axis direction and at an approximate center in the Z-axis direction of the right side surface 506. The port 515 opens on the negative side in the Z-axis direction with respect to the second recessed part 50B, slightly on the positive side in the Z-axis direction with respect to the axial center O, and slightly on the negative side in the Y-axis direction with respect to the port 514. The plurality of liquid passages 11 and the like are configured to connect the ports 51, the liquid reservoir chambers 521 and 522, the cylinder accommodating holes 53, the valve accommodating holes 54, and the hydraulic pressure sensor accommodating holes to one another.

A plurality of fixing holes 56 include motor fixing bolt holes, ECU fixing bolt holes 561 to 564, first-unit fixing bolt holes 565 and 566, housing fixing bolt holes 567 and 568, and pin holes 569. Each of the motor fixing bolt holes has a bottomed tubular shape, which has an axial center extending in the Y-axis direction, and opens on the front surface 501. Each of the ECU fixing bolt holes 561 to 564 has a tubular shape, which has an axial center extending in the Y-axis direction, and passes through the housing 5. The holes 561 and 562 are arranged on the negative side in the Z-axis direction. The holes 563 and 564 are arranged on the positive side in the Z-axis direction. The holes 561 and 562 are arranged at both corners between the bottom surface 503 and the side surfaces 505 and 506, and open on the front surface 501 and the rear surface 502. The holes 563 and 564 are arranged at corners between the top surface 504 and the second flat surface parts 508 of the recessed parts 50 as viewed in the Y-axis direction, and open on the first flat surface parts 507 and the rear surface 502. The hole 563 is arranged between the ports 512b and 512c, and the hole 564 is arranged between the ports 512a and 512d, as viewed in the X-axis direction. Each of the first-unit fixing bolt holes 565 and 566 has a bottomed tubular shape, which has an axial center extending in the X-axis direction, and opens on the right side surface 506. The first hole 565 opens slightly on the negative side in the Y-axis direction and on the positive side in the Z-axis direction on the right side surface 506. The first hole 565 opens adjacently to a corner between the first flat surface part 507 and the third flat surface part 509 of the second recessed part 50B as viewed in the X-axis direction. A position in the Z-axis direction of the first hole 565 is an approximate center position between the unit connection ports 514 and 515. A position in the Y-axis direction of the first hole 565 is approximately the same as a position in the Y-axis direction of the port 514. The second hole 566 opens slightly on the negative side in the Y-axis direction and on the negative side in the Z-axis direction on the right side surface 506. A position in the Z-axis direction of the second hole 566 is on the negative side in the Z-axis direction with respect to the opening of the cylinder accommodating hole 53E. A position in the Y-axis direction of the second hole 566 is approximately the same as the position in the Y-axis direction of the port 515. Each of the housing fixing bolt holes 567 and 568 has a bottomed tubular shape, which has an axial center extending in the Y-axis direction, and opens at both ends in the X-axis direction, and on the negative side in the Z-axis direction of the front surface 501. The hole 567 on the negative side in the X-axis direction is adjacent to the left side surface 505 and is arranged between the surface 505 and the second liquid reservoir chamber 522, in the x-axis direction, and is arranged between the cylinder accommodating hole 53B and the bolt hole 561 in the Z-axis direction. The hole 568 on the positive side in the X-axis direction is adjacent to the right side surface 506 in the x-axis direction, and is arranged between the cylinder accommodating hole 53E and the bolt hole 562 in the Z-axis direction. Each of the housing fixing pin holes 569 has a bottomed tubular shape, which has an axial center extending in the Z-axis direction, and opens on the negative side in the Y-axis direction on the bottom surface 503. The holes 569 include a first hole 569A opening at an approximate center in the X-axis direction on the bottom surface 503, and second and third holes 569B and 569C opening at both sides in the X-axis direction on the bottom surface 503.

The motor 20 includes the motor housing 200. The motor 20 is arranged on the front surface 501 of the housing 5, and the motor housing 200 is mounted to the front surface 501. The front surface 501 functions as a motor mounting surface. The master cylinder port 511 is positioned on the positive side in the Z-axis direction with respect to the motor housing 200. The motor housing 200 has a bottomed tubular shape, and includes a tubular part 201, a bottom part 202, and a flange part 203. The tubular part 201 accommodates a magnet serving as a stator, a rotor, and the like on an inner peripheral side in a case of a DC brush motor as an example. A rotation shaft of the motor 20 extends on an axial center of the tubular part 201. The bottom part 202 closes one side in the axial direction of the tubular part 201. The flange part 203 is provided at an end on the other side (opening side) in the axial direction of the tubular part 201, and extends from an outer peripheral surface of the tubular part 201 to a radially outer side. Bolt holes pass through the flange part 203. A bolt b1 is inserted into each of the bolt holes. The bolt b1 is fastened to the motor fixing bolt hole of the housing 5 (front surface 501). A conductive member (power supply connector) for current supply is connected to the rotor via a brush. The conductive member is accommodated in (mounted to) the power supply hole 55, and extends from the rear surface 502 toward the negative side in the Y-axis direction.

The ECU 90 is provided integrally with the housing 5. The ECU 90 is arranged on and mounted to the rear surface 502 of the housing 5. The ECU 90 includes a control board and a case (control unit housing) 901. The control board is configured to control current supply states to the motor 20 and the solenoids such as the electromagnetic valves 21 and the like. The control board is accommodated in the case 901. The case 901 is mounted to the rear surface 502 (bolt holes 561 to 564) of the housing 5 through bolts b2. The rear surface 502 functions as a case mounting surface. The bolt holes 561 to 564 function as fixing parts configured to fix the ECU 90 to the housing 5. A head part of the bolt b2 is arranged on the front surface 501 side. A shaft part of the bolt b2 passes through each of the bolt holes 561 to 564, and a male thread on a tip side of the shaft part is threadedly engaged with a female thread on the case 901 side. The case 901 is threadedly fixed to the rear surface 502 of the housing 5 with axial forces of the bolts b2. The head parts of the bolts b2 protrude in the first recessed part 50A and the second recessed part 50B, respectively. The head parts are accommodated inside the recessed parts 50. In FIG. 8 to FIG. 10, illustration of the bolts b2 on the negative side in the Z-axis direction is omitted. The case 901 is a cover member made of a resin material, and includes a board accommodating part 902 and a connector part 903. The board accommodating part 902 is configured to accommodate the control board and a part of the solenoids such as the electromagnetic valves 21 (hereinafter referred to as “control board and the like”). The board accommodating part 902 includes a lid part 902a. The lid part 902a covers the control board and the like for isolation from the outside. The control board is mounted to the board accommodating part 902 approximately in parallel with the rear surface 502. Terminals of the solenoids such as the electromagnetic valves 21, terminals of the hydraulic pressure sensor 91 and the like, and the conductive member from the motor 20 protrude from the rear surface 502. The terminals and the conductive member extend toward the negative side in the Y-axis direction, and are connected to the control board. The connector part 903 is arranged on the negative side in the X-axis direction with respect to the terminals and the conductive member in the board accommodating part 902, and protrudes toward the positive side in the Y-axis direction of the board accommodating part 902. The connector part 903 is arranged slightly on an outside (on the negative side in the X-axis direction) with respect to the left side surface 505 of the housing 5 as viewed from the Y-axis direction. Terminals of the connector part 903 are exposed toward the positive side in the Y-axis direction, and extend to the negative side in the Y-axis direction to be connected to the control board. Each of the terminals (exposed toward the positive side in the Y-axis direction) of the connector part 903 can be connected to external devices including the stroke sensor 94 and a liquid level sensor of the reservoir tank 8. Electrical connections between the external devices and the control board (ECU 90) are achieved by another connector connected to the external devices being inserted into the connector part 903 from the positive side in the Y-axis direction. Moreover, a current supply is carried out from an external power supply (battery) to the control board via the connector part 903. The conductive member functions as a connection part configured to electrically connect the control board and (the rotor of) the motor 20 to each other, and a current is supplied to the motor 20 from the control board via the conductive member.

The first unit 1A is arranged on the right side surface 506 of the housing 5, and mounted to the right side surface 506. The right side surface 506 functions as a first unit mounting surface. An end on the positive side in the Z-axis direction of the housing 3 of the first unit 1A is positioned slightly on the negative side in the Z-axis direction with respect to an end (top surface 504) on the positive side in the Z-axis direction of the housing 5 of the second unit 1B. An end on the negative side in the Z-axis direction of the housing 3 is positioned slightly on the negative side in the Z-axis direction with respect to an end (bottom surface 503) on the negative side in the Z-axis direction of the housing 5, and is positioned slightly on the positive side in the Z-axis direction with respect to an end on the negative side in the Z-axis direction of the second unit 1B (ECU 90). An end on the positive side in the Y-axis direction of the first unit 1A (including the bleeder valves BV) is positioned on the positive side in the Y-axis direction with respect to an end (front surface 501) on the positive side in the Y-axis direction of the housing 5, and is positioned on the negative side in the Y-axis direction with respect to an end (bottom part 202) on the positive side in the Y-axis direction of the second unit B (motor housing 200). An end on the negative side in the Y-axis direction of the housing 3 is positioned slightly on the positive side in the Y-axis direction with respect to an end (rear surface 502) on the negative side in the Y-axis direction of the housing 5.

The surfaces 381 to 383 of the housing 3 are held in abutment against the right side surface 506 of the housing 5. Under a state in which an axial center of the bolt hole 391 of the first flange part 351 and an axial center of the bolt hole 565 of the housing 5 approximately match each other, and an axial center of the bolt hole 392 of the second flange part 352 and an axial center of the bolt hole 566 of the housing 5 approximately match each other, the first unit connection port 514 overlaps the first simulator connection port 306A, and the second unit connection port 515 overlaps the second simulator connection port 306B, as viewed in the X-axis direction (an axial direction of the connection ports 306). As a result of the former overlap, the port 306A is connected to the positive-pressure liquid passage 16 (port 514) opening on the outer surface of the housing 5. As a result of the latter overlap, the port 306B is connected to the back-pressure liquid passage 17 (port 515) opening on the outer surface of the housing 5. The housing 3 is fixed to the right side surface 506 of the housing 5 in this state. The first and second flange parts 351 and 352 are fixed to the housing 5 through bolts b3, respectively. Head parts of the bolts b3 are arranged on the positive side in the X-axis direction of the first and second flange parts 351 and 352. A shaft part of the bolt b3 passes through each of the bolt holes 391 and 392, and a male thread on a tip side of the shaft part is threadedly engaged with a female thread of each of the bolt holes 565 and 566 of the housing 5. The flange parts 351 and 352 are threadedly fixed to the right side surface 506 between the head parts of the bolts b3 and the right side surface 506 of the housing 5 with axial forces of the bolts b3. The bolt holes 565 and 566 function as fixing parts configured to fix the first unit 1A (housing 3) to the second unit 1B (housing 5). A leak of the brake fluid from the openings of the ports 306, 514, and 515 to the outside via a gap between the surfaces 381 and 382 and the right side surface 506 is suppressed by a close contact of the surfaces 381, 382, and 506 with the axial forces of the bolts b2. The first flange part 351 is provided integrally with the liquid passage parts 361 and 362. Thus, the connection between the ports 306A and 306B and the ports 514 and 515 can more efficiently be enhanced through fixing the first flange part 351 to the housing 5. Moreover, the second flange part 352 is provided at a position separated from the first flange part 351 in an axial direction of the housing 3 (stroke simulator 4). Thus, strength of the mounting of the housing 3 which is elongated in the axial direction to the housing 5 can be increased. A gap may be present between the surface 383 of the first flange part 351 and the right side surface 506. Moreover, a gasket (seal member) may be provided between the surfaces 381 and 382 and the right side surface 506. For example, O rings may be provided on the surfaces 381 and 382 or the right side surface 506 so as to surround openings of the ports 306, 514, and 515. Moreover, a gasket in a sheet form may be interposed between the surfaces 381 and 382 and the right side surface 506, or a member that is not limited to a gasket, but includes a liquid passage coupling the port 306 and 514 (515) to each other may be interposed.

A mount configured to support the housing 5 is a pedestal formed by bending a metal plate, and is fixed with bolts or the like to the vehicle body side (usually a mounting member provided on a bottom surface or a side surface in the engine room). The mount includes a first mount part arranged approximately in parallel with the bottom surface 503 and a second mount part arranged approximately in parallel with the front surface 501. A pin is press-fitted and fixed to each of the pin holes 569 of the housing 5. The pins protruding from the bottom surface 503 are inserted into holes in the first mount part. An insulator is provided between an inner peripheral surface of the hole and an outer peripheral surface of the pin. The insulator is an elastic member configured to suppress (insulate) vibration, and is formed of a rubber material. The pins are configured to fix the bottom surface 503 to the first mount part via the insulator. The pins and the insulator are structures configured to support the housing 5 (bottom surface 503), and function as a support part for the bottom surface 503. Any of the first to third pin holes 569A to 569C may be used. A bolt is inserted into and fixed to each of the bolt holes 567 and 568 of the housing 5. The bolts protruding from the front surface 501 are inserted into cutout parts of the second mount part. An insulator is provided between an inner periphery of the cutout part and an outer peripheral surface of the bolt. The bolts are configured to fix the front surface 501 to the second mount part via the insulators. The bolts and the like are structures configured to support the housing 5 (front surface 501), and function as a support part for the front surface 501. The holes 567 to 569 function as a fixing part configured to fix the housing 5 to the vehicle body side (mount). The mount may include a third mount part arranged approximately in parallel with the right side surface 506 of the housing 5 (adjacently to the positive side in the X-axis direction of the first unit 1A). In this case, the first unit 1A may include bolt holes on an end surface on the positive side in the X-axis direction of the housing 3 (for example, the second part 362B of the second liquid passage part 362), and the first unit 1A may be fixed to the third mount part via bolts inserted into the bolt holes.

Next, description is given of a configuration of the third unit 1C. As illustrated in FIG. 2, the third unit 1C includes a housing 6, a master cylinder 7, a reservoir tank 8, and a stroke sensor 94. In the following, for the sake of description, an x axis extending in an axial direction of the master cylinder 7 is provided, and a side of the master cylinder 7 with respect to the brake pedal BP is set to a positive direction. The housing 6 internally accommodates the master cylinder 7. A cylinder 60, supplement ports 62, and supply ports 63 are formed inside the housing 6. The cylinder 60 has a bottomed tubular shape extending in an x-axis direction, a positive side in the x-axis direction is closed, and a negative side in the x-axis direction is opened. The cylinder 60 includes a small-diameter part 601 on the positive side in the x-axis direction, and a large-diameter part 602 on the negative side in the x-axis direction. The small-diameter part 601 includes two seal grooves 603 and 604 and one port 605 for each of the P and S systems. Each of the seal grooves 603 and 604 and the port 605 has an annular shape extending in a circumferential direction about an axial center of the cylinder 60. The port 605 is arranged between the grooves 603 and 604. The supplement port 62 extends from the port 605, and opens on an outer surface of the housing 6. The supply port 63 extends from the small-diameter part 601 of the cylinder 60, and opens on the outer surface of the housing 6. The other end of the primary pipe 10MP is connected to the supply port 63P, and the other end of the secondary pipe 10MS is connected to the supply port 63S. As illustrated in FIG. 1, a flange part 64 having a plate shape is provided at a position between the small-diameter part 601 and the large-diameter part 602 on an outer periphery of the housing 6. The flange part 64 is fixed to a dash panel on the vehicle body side through bolts.

The master cylinder 7 is a second hydraulic pressure source capable of supplying an operation hydraulic pressure to the wheel cylinders W/C, is connected to the brake pedal BP via a pushrod PR, and is operated in accordance with an operation on the brake pedal BP by the driver. The master cylinder 7 includes pistons 71 and springs 72. The master cylinder 7 is of the tandem type, and includes, as pistons 71, a primary piston 71P connected to the pushrod PR and a secondary piston 71S of a free piston type in series. The pistons 71 are accommodated in the cylinder 60, and define hydraulic pressure chambers 70. Each of the pistons 71P and 71S has a bottomed tubular shape, and is movable in the x-axis direction along an inner peripheral surface of the small-diameter part 601 in accordance with the operation of the brake pedal BP. The piston 71 includes a first recessed part 711 and a second recessed part 712, and a bottom part each of the first and second recessed parts 711 and 712 is formed by a partition wall 710. The first recessed part 711 is arranged on the positive side in the x-axis direction, and the second recessed part 712 is arranged on the negative side in the x-axis direction. A hole 713 passes through a peripheral wall of the first recessed part 711. In the small-diameter part 601, a primary chamber 70P is defined between the primary piston 71P (first recessed part 711P) and the secondary piston 71S (second recessed part 712S). A secondary chamber 70S is defined between the secondary piston 71S (first recessed part 711S) and an end of the small-diameter part 601 on the positive side in the x-axis direction. The supply ports 63P and 63S always open in the chambers 70P and 70S, respectively. Regarding the primary piston 71P, an end of the pushrod PR on the positive side in the x-axis direction is accommodated in the second recessed part 712P, and is held in abutment against the partition wall 710P. The stroke sensor 94 includes a magnet and a sensor main body (Hall element or the like). The magnet is provided in the primary piston 71P, and the sensor main body is mounted to an outer surface of the housing 6. A flange part PR1 is provided on the pushrod PR. A movement of the pushrod PR toward the negative side in the x-axis direction is restricted through an abutment between a stopper part 600 provided in an opening of the cylinder 60 (large-diameter part 602), and the flange part PR1.

The springs 72P and 72S are coil springs serving as elastic members. Units of the springs 72P and 72S including retainer members and stopper members similar to those of the spring unit of the stroke simulator 4 are provided in the primary chamber 70P and the secondary chamber 70S, respectively. The unit of the spring 72P is provided between the partition wall 710P and a partition wall 710S. The unit of the spring 72S is provided between an end on the positive side in the x-axis direction of the small-diameter part 601 and the partition wall 710S. The spring 72 functions as a return spring configured to always bias the piston 71 toward the negative side in the x-axis direction. Seal members 731 and 732 each having a cup shape are provided in the seal grooves 603 and 604, respectively. A lip part of each of the seal members 731 and 732 is in slide contact with an outer peripheral surface of the piston 71. On the primary side, the seal member 731P on the negative side in the x-axis direction is configured to suppress a flow of the brake fluid from the positive side in the x-axis direction (port 605P) toward the negative side in the x-axis direction (large-diameter part 602). The seal member 732P on the positive side in the x-axis direction is configured to suppress a flow of the brake fluid toward the negative side in the x-axis direction (port 605P), and permit a flow of the brake fluid toward the positive side in the x-axis direction (primary chamber 70P). On the secondary side, the seal member 731S on the negative side in the x-axis direction is configured to suppress a flow of the brake fluid from the negative side in the x-axis direction (primary chamber 70P) toward the positive side in the x-axis direction (port 605S). The seal member 732S on the positive side in the x-axis direction is configured to suppress a flow of the brake fluid toward the negative side in the x-axis direction (port 605S), and permit a flow of the brake fluid toward the positive side in the x-axis direction (secondary chamber 70S). In an initial state in which both the pistons 71P and 71S are maximally displaced toward the negative side in the x-axis direction, the holes 713 are positioned between portions at which both the seal members 731 and 732 (lip parts) and the outer peripheral surfaces of the pistons 71 are in contact with each other (on sides closer to the seal members 732).

The reservoir tank 8 is a brake fluid source for reserving the brake fluid, and is a low-pressure part opened to the atmospheric pressure. The reservoir tank 8 is provided on the positive side in the Z-axis direction of the housing 6. A bottom part side (the negative side in the Z-axis direction) of the reservoir tank 8 is partitioned into three chambers 83 by a first partition wall 821 and a second partition wall 822. First chambers 83P and 83S are connected to the supplement ports 62P and 62S of the housing 6, respectively. The supply port 81 opens in a second chamber 83R. The other end of the suction pipe 10R is connected to the supply port 81 via a nipple 10R1.

Next, description is given of a control configuration. The ECU 90 is configured to receive inputs of detection values of the stroke sensor 94, the hydraulic pressure sensor 91, and the like, and information on the travel state from the vehicle side, and control, based on a built-in program, the opening/closing operations of the electromagnetic valves 21 and the like and the number of revolutions (namely a discharge amount of the pump 2) of the motor 20, to thereby control the wheel cylinder hydraulic pressures (hydraulic pressure braking forces) for the respective wheels W. With such control, the ECU 90 carries out various types of brake control (for example, antilock brake control of suppressing slip of wheels W caused by the braking, boost control of decreasing a brake operation force of the driver, brake control for motion control for the vehicle, automatic brake control such as preceding vehicle following control, and regeneration cooperative brake control). The motion control for the vehicle includes stabilization control of vehicle behavior such as prevention of lateral slipping. The regeneration cooperative brake control controls the wheel cylinder hydraulic pressures so as to achieve a target deceleration (target braking forces) in cooperation with regenerative braking.

The ECU 90 includes a brake operation amount detection part 90a, a target wheel cylinder hydraulic pressure calculation part 90b, a stepping force braking generation part 90c, a boost control part 90d, and a control switching part 90e. The stroke sensor 94 is configured to detect a stroke (pedal stroke) of the primary piston 71P. The brake operation amount detection part 90a is configured to receive an input of the detection value of the stroke sensor 94, to thereby detect a displacement amount (pedal stroke) of the brake pedal BP as a brake operation amount. The target wheel cylinder hydraulic pressure calculation part 90b is configured to calculate a target wheel cylinder hydraulic pressure. Specifically, the target wheel cylinder hydraulic pressure calculation part 90b is configured to calculate, based on the detected pedal stroke, the target wheel cylinder hydraulic pressure for achieving a predetermined boost ratio, namely an ideal relationship between the pedal stroke and a required brake hydraulic pressure by the driver (vehicle deceleration required by the driver). Moreover, the target wheel cylinder hydraulic pressure calculation part 90b is configured to calculate the target wheel cylinder hydraulic pressure based on a relationship with a regenerative braking force during the regeneration cooperative brake control. For example, the target wheel cylinder hydraulic pressure calculation part 90b is configured to calculate such a target wheel cylinder hydraulic pressure that a sum of a regenerative braking force input from a control unit of a regenerative braking device of a vehicle, and a hydraulic pressure braking force corresponding to the target wheel cylinder hydraulic pressure satisfies the vehicle deceleration required by the driver. During the motion control, the target wheel cylinder hydraulic pressure calculation part 90b calculates the target wheel cylinder hydraulic pressures for the respective wheels W in order to achieve a desired vehicle motion state, for example, based on a detected vehicle motion state amount (for example, a lateral acceleration). The stepping force braking generation part 90c is configured to set the pump 2 to a non-operation state, and control the shutoff valves 21 toward the open direction, control the SS/V IN 28 toward the closed direction, and control the SS/V OUT 29 toward the closed direction. The boost control part 90d is configured to operate the pump 2 upon the brake operation by the driver, and control the shutoff valves 21 toward the closed direction, and the communication valves 23 toward the open direction.

Moreover, the ECU 90 includes a sudden brake operation state determination part 90f and a second stepping force braking generation part 90g. The sudden brake operation state determination part 90f is configured to detect a brake operate state based on inputs from the brake operation amount detection part 90a and the like, to thereby determine whether or not the brake operation state is a predetermined sudden brake operation state. For example, the sudden brake operation state determination part 90f is configured to determine whether or not a change amount of the pedal stroke per unit time exceeds a predetermined threshold. The control switching part 90e is configured to switch the control so that the wheel cylinder hydraulic pressures are generated by the second stepping force braking generation part 90 when the brake operation state is determined to be the sudden brake operations state. The second stepping force braking generation part 90g is configured to operate the pump 2, and control the shutoff valves 21 toward the closed direction, the SS/V IN 28 toward the open direction, and the SS/V OUT 29 toward the closed direction. Then, when the brake operation state is no longer determined to be the sudden brake operation state and/or when a predetermined condition indicating that a discharge performance of the pump 2 becomes sufficient is satisfied, the control switching part 90e switches the control so as to cause the boost control part 90d to generate the wheel cylinder hydraulic pressures. In other words, the boost control part 90d is configured to control the SS/V IN 28 toward the closed direction, and control the SS/V OUT 29 toward the open direction.

Description is now given of the operation.

(Hydraulic Pressure Control Function)

The second unit 1B can supply the master cylinder pressure to the respective wheel cylinders W/C. Under the state in which the shutoff valves 21 are controlled toward the open direction by the stepping force braking generation part 90c, the liquid passage system (for example, the supply liquid passages 11) connecting the hydraulic pressure chambers 70 of the master cylinder 7 and the wheel cylinders W/C to each other achieves stepping force braking (non-boost control) of generating the wheel cylinder hydraulic pressures through the master cylinder pressure generated by the pedal stepping force. Each of the hydraulic pressure chambers 70P and 70S is configured to be supplemented with the brake fluid from the reservoir tank 8, thereby generating the hydraulic pressure (master cylinder pressure) through the movement of the piston 71. The brake fluid, which has flowed out from the master cylinder 7 as a result of the brake operation by the driver, flows to the master cylinder pipes 10M, and is taken into the supply liquid passages 11 of the second unit 1B via the master cylinder ports 511. The wheel cylinders W/C (FL) and W/C (RR) are pressurized by the master cylinder pressure generated in the primary chamber 70P via the liquid passage (supply liquid passage 11P) in the P system. Moreover, the wheel cylinders W/C (FR) and W/C (RL) are pressurized by the master cylinder pressure generated in the secondary chamber 70S via the liquid passage (supply liquid passage 11S) in the S system. The third unit 1C does not have a negative-pressure booster configured to use a negative pressure generated by the engine of the vehicle or a negative-pressure pump provided independently, to thereby boost the brake operation force by the driver. The SS/V OUT 29 is controlled toward the closed direction, and the stroke simulator 4 does not thus function. In other words, the operation of the piston 41 is suppressed, and the inflow of the brake fluid from the hydraulic pressure chamber 70 (secondary chamber 70S) to the positive-pressure chamber 401 is thus suppressed. As a result, the wheel cylinder hydraulic pressures can more efficiently be boosted. The S/V IN 28 may be controlled toward the open direction.

The second unit 1B can use the hydraulic pressure generated by the pump 2 to individually control, independently of the brake operation by the driver, the hydraulic pressures in the respective wheel cylinders W/C. When the shutoff valves 21 are controlled toward the closed direction, the communication between the master cylinder 7 and the wheel cylinders W/C is shut off, and the second unit 1B is brought into a state in which the wheel cylinder hydraulic pressures can be generated by the pump 2. The second unit 1B is configured to supply the brake fluid pressurized by the pump 2 to the brake activation units via the wheel cylinder pipes 10W, thereby to generate the brake hydraulic pressures (wheel cylinder pressures). The braking system (the suction liquid passage 12, the discharge liquid passage 13, and the like) connecting the first liquid reservoir 521 and the wheel cylinders W/C to each other functions as a so-called brake-by-wire system configured to generate the wheel cylinder hydraulic pressures through the hydraulic pressure generated by the pump 2, to thereby achieve the boost control, the regeneration cooperative control, and the like. The boost control part 90d is configured to carry out the boost control to thereby generate the hydraulic pressure braking force that is not sufficiently generated by the brake operation force of the driver. Specifically, the boost control part 90d is configured to control the pressure-regulating valve 24 while operating the pump 2 at a predetermined number of revolutions to adjust the brake fluid amount supplied from the pump 2 to the wheel cylinders W/C, to thereby achieve the target wheel cylinder hydraulic pressures. In other words, the braking system 1 is configured to operate the pump 2 of the second unit 1B in place of an engine negative-pressure booster, to thereby provide a boost function of assisting the brake operation force. Moreover, the boost control part 90d is configured to control the SS/V IN 28 toward the closed direction, and control the SS/V OUT 29 toward the open direction. With such control, the boost control part 90d causes the stroke simulator 4 to function.

The pedal stroke is generated as a result of inflow of the brake fluid from the master cylinder 7 into the positive-pressure chamber 401 of the strike simulator 4 in response to the brake operation by the driver, and a reaction force (pedal reaction force) against a brake operation by the driver is generated by the biasing force of the elastic body. The brake fluid, which has flowed out from the secondary chamber 70S as a result of the brake operation by the driver, flows to the secondary pipe 10MS, and is taken into the positive-pressure liquid passage 16 via the supply liquid passage 11S of the second unit 1B. The positive-pressure liquid passage 16 is connected to the positive-pressure chamber 401 via the first unit connection port 514, the first simulator connection port 306A of the first unit 1A, and the first connection liquid passage 304. The positive-pressure chamber 401 has a tubular shape, and a cross sectional area thereof in the radial direction is larger than a flow passage cross sectional area of the first connection liquid passage 304 opening in the positive-pressure chamber 401. The positive-pressure chamber 401 is a volume chamber in the first connection liquid passage 304. When the hydraulic pressure (master cylinder pressure) equal to or higher than a predetermined value is applied to a pressure receiving surface of the piston 41 in the positive-pressure chamber 401, the piston 41 moves toward the back-pressure chamber 402 side in the axial direction while compressing the spring 431 and the like. On this occasion, the volume of the positive-pressure chamber 401 increases, and, simultaneously, the volume of the back-pressure chamber 402 decreases. As a result, the brake fluid, which has flowed out from the secondary chamber 70S, flows into the inside of the positive-pressure chamber 401. Simultaneously, the brake fluid flows out from the back-pressure chamber 402, and the brake fluid in the back-pressure chamber 402 is thus discharged. The back-pressure chamber 402 has a tubular shape, and a cross sectional area thereof in the radial direction is larger than a flow passage cross sectional area of the second connection liquid passage 305 opening in the back-pressure chamber 402. The back-pressure chamber 402 is a volume chamber in the second connection liquid passage 305. The back-pressure chamber 402 is connected to the back-pressure liquid passage 17 via the second connection liquid passage 305, the second simulator connection port 306B, and the second connection port 515 of the second unit 1B. The brake fluid, which has flowed out from the back-pressure chamber 402 as a result of the brake operation by the driver, is taken into the liquid passage 17. The stroke simulator 4 is configured to suck the brake fluid from the master cylinder 7 in this way to simulate liquid rigidity of the wheel cylinders W/C, thereby to reproduce a sense of stepping on the pedal. When the pressure in the positive-pressure chamber 401 falls below a predetermined pressure, the piston 41 is returned to an initial position by the biasing force (elastic force) of the spring 431 and the like. When the piston 41 is at the initial position, a first gap in the Z-axis direction exists between the first damper 471 and the head part 451 of the stopper member 45, and a second gap in the Z-axis direction exits between the second damper 472 and the bottom part 461 of the seat member 46. When the piston 41 strokes toward the negative side in the Z-axis direction, and the first spring 431 is consequently compressed by a length equal to or more than the first gap in the Z-axis direction, the first damper 471 is sandwiched between the protruded part 413 and the head part 451, and starts elastic deformation. When the second spring 432 is compressed by a length equal to or more than the second gap in the Z-axis direction, the second damper 472 comes in contact with the bottom part 461, and starts elastic deformation. As a result, impact is alleviated, and a characteristic of a relationship between the pedal stepping force (pedal reaction force) and the pedal stroke can be adjusted. Thus, pedal feeling is improved.

The SS/V OUT 29, the SS/V IN 28, and the check valve 280 are configured to adjust the flow of the brake fluid, which has flowed out from the back pressure chamber 402 to the back-pressure liquid passage 17. Those valves permit or inhibit the flow of the brake fluid, which has flowed into the liquid passage 17, to any of the low pressure parts (the first liquid reservoir chamber 521 and the wheel cylinders W/C), to thereby permit or inhibit the flow of the brake fluid from the master cylinder 7 to the stroke simulator 4 (positive-pressure chamber 401). With such actions, those valves adjust the operation of the stroke simulator 4. The valves 29 and 28 function as switching electromagnetic valves configured to switch absence and presence of the inflow of the working fluid into the stroke simulator 4. Moreover, the valves 29, 28, and 280 function as a switching part configured to switch a supply destination (outflow destination) of the brake fluid, which has flowed into the back-pressure liquid passage 17, between the first fluid reservoir chamber 521 and the wheel cylinders W/C.

The second stepping force brake generation part 90g is configured to achieve a second stepping force brake, which uses the brake fluid flowing out from the back-pressure chamber 402 to generate the wheel cylinder hydraulic pressures until the pump 2 becomes capable of generating sufficiently high wheel cylinder hydraulic pressures. Specifically, the second stepping force brake generation part 90g is configured to control the SS/V OUT 29 toward the closed direction. As a result, the brake fluid, which has flowed from the back-pressure chamber 402 into the back-pressure liquid passage 17, flows toward the supply liquid passages 11 via the SS/V IN 28 (first simulator liquid passage 18) and the check valve 280 (bypass liquid passage 180). In other words, the supply destination of the brake fluid flowing into the back-pressure liquid passage 17 is switched to the wheel cylinders W/C. Thus, boost responsiveness of the wheel cylinder hydraulic pressures can be secured. When the pressure on the wheel cylinder W/C side exceeds the pressure on the back-pressure chamber 402 side, the check valve 280 is automatically closed, and a counter flow of the brake fluid from the wheel cylinder W/C side to the back-pressure chamber 402 side is suppressed. The shutoff valves 21 may be controlled toward the open direction. Moreover, the SS/V IN 28 may be controlled toward the closed direction, and, in this case, the brake fluid from the back-pressure chamber 402 is supplied to the wheel cylinder W/C side via the check valve 280 (in the open state because the pressure on the wheel cylinder W/C side is still lower than that on the back-pressure chamber 402 side). In this embodiment, the brake fluid can efficiently be supplied from the back-pressure chamber 402 side to the wheel cylinder W/C side by controlling the SS/V IN 28 toward the open direction.

When the brake operation state is determined to be the sudden brake operation state, the control switching part 90e controls the SS/V OUT 29 toward the closed direction, to thereby switch the supply destination of the brake fluid to the wheel cylinders W/C. Thus, the second stepping force braking can appropriately be achieved when the boost responsiveness of the wheel cylinder hydraulic pressures is required. The pump 2 is a reciprocating pump, and the responsiveness is relatively high. Thus, a period until the pump 2 comes to be able to generate sufficient wheel cylinder pressures after start of the operation is relatively short, and a period in which the second stepping force braking is operating can thus be decreased. The pump 2 may be a gear pump. When the predetermined condition indicating that the discharge performance of the pump 2 has become sufficient is satisfied, the control switching part 90e controls the SS/V OUT 29 toward the open direction. As a result, the brake fluid, which has flowed from the back-pressure chamber 402 into the back pressure liquid passage 17, flows toward the first liquid reservoir chamber 521 via the SS/V OUT 29 (second simulator liquid passage 19). In other words, the supply destination of the brake fluid flowing from the back-pressure chamber 402 is switched to the first liquid reservoir chamber 521. Thus, the stroke simulator 4 is operated, and excellent pedal feeling can be secured. Even when such a failure that the SS/V OUT 29 is stuck in the closed state occurs during operation of the stroke simulator 4, the piston 41 can return to the initial position by the brake fluid being supplied from the first liquid reservoir chamber 521 side to the back-pressure chamber 402 via the check valve 290.

(Reservoir Function)

The brake fluid is supplemented from the reservoir tank 8 to the first liquid reservoir chamber 521 via the suction pipe 10R, and the first liquid reservoir chamber 521 functions as a reservoir (internal reservoir), to thereby supply the brake fluid to the suction parts of the respective pump parts 2A to 2E. The respective pump parts 2A to 2E are configured to suck and discharge the brake fluid via the first liquid reservoir chamber 521. When the suction pipe 10R is detached from the nipple 10R1 or 10R2, or a band for tightening the suction pipe 100R to the nipple 10R1 or 10R2 is loosened, and the brake fluid thus leaks from the suction pipe 10R, the first liquid reservoir chamber 521 functions as a reservoir configured to reserve the brake fluid. The pump 2 can suck and discharge the brake fluid in the first reservoir chamber 521, to generate the wheel cylinder hydraulic pressures, and to generate the braking torque in the vehicle to which the braking system 1 is mounted. Even when the leakage of fluid from the suction pipe 10R occurs, the brake fluid in the second chamber 83R of the reservoir tank 8 decreases, but the brake fluid in the first chambers 83P and 83s is secured, and thus the stepping force braking can continuously be achieved. When the first liquid reservoir chamber 521 is arranged on a top side in the vertical direction with respect to the suction parts of the pump parts 2A to 2E, the brake fluid can easily be supplied to the respective suction parts from the first liquid reservoir chamber 521 via the suction liquid passage 12 through the self-weight of the brake fluid. Moreover, stagnation of the air inside the suction liquid passage 12 is suppressed, thereby suppressing suction of the air (air bubbles) by the pump 2. The suction port 513 may open on the surface 501 or the like other than the top surface 504. In this embodiment, the suction port 513 opens on the top surface 504. Thus, the first liquid reservoir chamber 521 is arranged on the top side in the vertical direction in the housing 5, and the first liquid reservoir chamber 521 can easily be arranged on the top side in the vertical direction with respect to the suction parts of the pump parts 2A to 2E.

(Pump Function)

The plurality of pump parts 2A to 2E are provided. Axial centers of the two pump parts 2A, 2C, and the like opposed to each other across the axial center O are not on the same straight line, and form an angle larger than 0 degrees. Thus, phases of the suction/discharge strokes of the respective pump parts 2A to 2E are not synchronized with one another, and are thus shifted from one another. As a result, periodical variations (pulse pressures) of the respective pump parts 2A to 2E can be canceled one another, and the pulse pressures can be decreased as the entire pump 2. The plurality of pump parts 2A to 2E are arranged at approximately equal intervals in a circumferential direction. Therefore, a variation in magnitude of a sum of the discharge pressures of the plurality of pump parts 2A to 2E can be decreased as much as possible as the entire pump 2 through approximately uniform shifts of the phases of the suction/discharge strokes between the pump parts 2A to 2E. Thus, a significant pulse-pressure-decreasing effect can be obtained. The number of pump parts 2A to 2E may be an even number. In this embodiment, the number is an odd number equal to or more than three. Thus, compared with a case in which the number is an even number, the magnitude of the pulse pressure (range of the variation) as the entire pump 2 can easily be decreased by shifting the phases while the plurality of pump parts 2A to 2E are arranged at approximately equal intervals in the circumferential direction, and the effect of reducing the pulse pressure can thus significantly be attained. The number of the pump parts 2A to 2E is not limited to five, and may be, for example, three. In this embodiment, the number is five. Thus, compared with the case in which the number is three, the effect of reducing the pulse pressure can be improved, thereby being capable of attaining sufficient silence. Moreover, a sufficient discharge amount can be secured as the entire pump 2 while the size of the respective pump parts 2A to 2E is decreased, thereby suppressing an increase in size of the second unit 1B. Moreover, compared with the case in which the number is equal to or more than six, the increase in the number of the pump parts 2A to 2E can be suppressed, which is advantageous in terms of the layout and the like, and the size of the second unit 1B can easily be decreased.

(Drain Function)

The brake fluid leaking from the respective cylinder accommodating holes to the cam accommodating hole flows into the second liquid reservoir chamber 522 via the drain liquid passage, and is reserved in the chamber 522. Thus, entry of the brake fluid in the cam accommodating hole into the motor 20 is suppressed, and an operation performance of the motor 20 can be increased. The opening of the chamber 522 is closed by a lid member.

(Air Bleeding Function)

The second bleeder part 372 and the bleeder valves BV are provided on the back-pressure chamber 402 side. The liquid passages 17 and 18 and the like connected to the back-pressure chamber 402 are also connected to (the discharge parts of) the pump 2, and the second unit 1B is provided so as to be capable of switching the communication state between (the discharge parts of) the pump 2 and the back-pressure chamber 402. (The discharge parts of) the pump 2 and the back-pressure chamber 402 are caused to communicate with each other under a state in which the valves BV are opened. Then, the pump 2 is operated, thereby supplying the brake fluid from the pump 2 to the back-pressure chamber 402. Thus, the brake fluid discharged from the pump 2 pushes out air in the liquid passage 17 and the like and air in the back-pressure chamber 402, and is discharged from the valves BV together with the air. This operation is continuously carried out. Thus, a large amount of the air can thus be discharged, and the air is thus effectively bled.

(Decrease in Size and Improvement in Ease of Layout)

The braking system 1 includes the first unit 1A, the second unit 1B, and the third unit 1C. Mountability of the system 1 to the vehicle can thus be increased. The stroke simulator 4 (first unit 1A) is arranged integrally with the second unit 1B. Thus, compared with a case in which the stroke simulator 4 is arranged on the third unit 1C (master cylinder 7) side, an increase in size of the third unit 1C can be suppressed. The stroke simulator 4 is provided independently of the master cylinder 7, thereby decreasing the size of the component (third unit 1C) around the brake pedal BP. Thus, even in a case in which the master cylinder 7 protrudes toward a driver's seat side when the vehicle collides, a protruded amount can be decreased. Therefore, collision safety can be increased. Particularly, this is effective for a small-sized vehicle and the like in which a foot space of the driver's seat is limited. The stroke simulator 4 (first unit 1A) is arranged integrally with the second unit 1B. Thus, a pipe for connecting the stroke simulator 4 and the second unit 1B (positive-pressure liquid passage 16) to each other is not required. In other words, a pipe for connecting the positive-pressure chamber 401 and the second unit 1B to each other is not required. Moreover, in such a configuration that the brake fluid flows out from the back-pressure chamber 402 as a result of the movement of the piston 41 through the brake operation by the driver, a pipe for connecting the back-pressure chamber 402 and the second unit 1B (back-pressure liquid passage 17) to each other is not required. Thus, the number of pipes can be decreased as the entire braking system 1, an increase in complexity of the system 1 can thus be suppressed, and an increase in cost caused by the increase in the number of the pipes can be suppressed.

The electromagnetic valves 21 and the like and the hydraulic pressure sensor 91 and the like (hereinafter referred to as “electromagnetic valves and the like”) are arranged in the second unit 1B. The main electronic control devices are provided on the second unit 1B side, and the first unit 1A and the third unit 1C can thus be simplified. In terms of the third unit 1C, electromagnetic valves and the like are not arranged in the third unit 1C, an ECU configured to drive electromagnetic valves is not required in the third unit 1C, and the size of the third unit 1C can thus be decreased, thereby being capable of increasing the degree of freedom in the layout. Moreover, wires (harness) for controlling the electromagnetic valves and transmitting the signals of the hydraulic pressure sensors are not required between the third unit 1C and the ECU 90 (second unit 1B). Thus, an increase in complexity of the braking system 1 can be suppressed, and an increase in cost caused by an increase in the number of wires can be suppressed. The same holds true for the first unit 1A. For example, the second unit 1B includes the switching electromagnetic valves configured to switch the absence and presence of the inflow of the working fluid into the stroke simulator 4. In other words, the SS/V IN 28 and the SS/V OUT 29 are arranged in the second unit 1B. The electronic control devices relating to the stroke simulator 4 are provided on the second unit 1B side, and the first unit 1A can thus be simplified. The first unit 1A does not need an ECU configured to switch the operation of the stroke simulator 4, and wires (harness) for controlling the SS/V IN 28 and the like are not required between the first unit 1A and the ECU 90 (second unit 1B).

The ECU 90 is mounted to the housing 5, and the ECU 90 and the housing 5 (that accommodates the electromagnetic valves and the like) are integrated with each other as the second unit 1B. Thus, wires (harness) that connect the electromagnetic valves and the like and the ECU 90 to each other can be omitted. Specifically, terminals of solenoids of the electromagnetic valves 21 and the like and terminals of the hydraulic pressure sensor 91 and the like are directly connected to the control board (not via harnesses and connectors outside the housing 5). Thus, for example, the harness that connects the ECU 90 and the SS/V IN 28 and the like to each other can be omitted. The motor 20 is arranged in the second unit 1B, and the housing 5 (that accommodates the pump 2) and the motor 20 are integrated with each other as the second unit 1B. The second unit 1B functions as the pump device. Thus, wires (harness) that connect the motor 20 and the ECU 90 to each other can be omitted. Specifically, the conductive members for the current supply and the signal transmission to the motor 20 are accommodated in the power supply hole 55 of the housing 5, and are directly connected (not via harnesses and connectors outside the housing 5) to the control board. The conductive members function as a connection member that connects the control board and the motor 20 to each other. The housing 5 is arranged between the motor 20 and the ECU 90. In other words, the motor 20, the housing 5, and the ECU 90 are arrayed in the stated order along the axial center direction (Y-axis direction) of the motor 20. Specifically, the ECU 90 is mounted to the rear surface 502 on the opposite side of the front surface 501 to which the motor 20 is mounted. Thus, as viewed from the motor 20 side or the ECU 90 side (as viewed in the Y-axis direction), the motor 20 and the ECU 90 can be arranged so as to overlap each other. As a result, the area of the second unit 1B as viewed from the motor 20 side or the ECU 90 side can be decreased, and the size of the second unit 1B can thus be decreased. The weight of the second unit 1B can be decreased by decreasing the size of the second unit 1B.

The connector part 903 of the ECU 90 is adjacent to a surface 505 continuing to the front surface 501 and the rear surface 502 of the housing 5. In other words, the connector part 903 is not covered with the housing 5, and protrudes with respect to the surface 505 as viewed from the motor 20 side (the positive side in the Y-axis direction). Thus, the control board of the ECU 90 can be extended not only to a region overlapping the housing 5, but also to a region overlapping the connector part 903 (region adjacent to the left side surface 505), as viewed from the motor 20 side. The bolts b2 for mounting the ECU 90 to the rear surface 502 do not pass through the ECU 90 from the rear surface 502 (ECU 90) side so as to be fixed to the housing 5, but pass through the housing 5 from the front surface 501 side so as to be fixed to the ECU 90. When the bolts b2 pass through the ECU 90 (control board), the control board cannot be arranged at portions which the bolts b2 pass through. Moreover, when a control board is also arranged on the rear of the connector part 903, the control board cannot be arranged adjacent to the portions through which the bolts b2 pass. When the control board cannot be arranged, a wiring pattern cannot be extended to these portions, and devices cannot be mounted. In other words, a mounting area of the control board decreases. The bolts b2 are provided so as to pass through not the ECU 90, but the housing 5, and portions at which the bolts b2 and the control board interfere with each other can thus be eliminated. Thus, a large mounting area of the control board can be secured, which promotes adaptation to an increase in the number of functions of the ECU 90.

The terminals of the connector part 903 extend in the Y-axis direction. Thus, an increase in dimension of the second unit 1B as viewed in the Y-axis direction (in the X-axis direction) can be suppressed. The terminals of the connector part 903 are exposed toward the motor 20 side (positive side in the Y-axis direction). Thus, a connector (harness) connected to the connector part 903 overlaps the housing 5 and the like in the axial direction (Y-axis direction) of the motor 20, and an increase in dimension in the Y-axis direction (axial direction of the motor 20) of the second unit 1B including the connector (harness) can be suppressed. The connector part 903 extends in the horizontal direction under the state in which the connector part 903 is mounted to the vehicle. As a result, while the connection of the harness to the connector part 903 can be facilitated, entry of water into the connector part 903 can be suppressed. The connector part 903 is adjacent to the left side surface 505 of the housing 5. Thus, compared with a case in which the connector part 903 is adjacent to the top surface 504, interference between the connector (harness) connected to the connector part 903 and the pipes 10W and 10R connected to the ports 512 and 513 of the top surface 504 can be suppressed. Moreover, interference between the connector (harness) and the vehicle-body-side member (mount) which is opposed to the bottom surface 503 can be suppressed compared with a case in which the connector part 903 is adjacent to the bottom surface 503. In other words, the connection of the connector (harness) to the connector part 903 can be facilitated. Thus, mounting workability of the braking system 1 in the vehicle can be improved.

The first unit 1A is mounted to the surface 506 other than the front surface 501 to which the motor 20 is mounted on the housing 5. Thus, the area of the front surface 501 can be decreased, thereby decreasing the size of the housing 5 while interference between the first unit 1A and the motor 20 is suppressed compared with the case in which the first unit 1A is mounted to the front surface 501. Thus, the size of the second unit 1B including the first unit 1A can be decreased, and restriction on the layout upon the mounting to the vehicle can be suppressed. The first unit 1A is mounted to the surface 506 other than the rear surface 502 to which the ECU 90 is mounted on the housing 5. Thus, the area of the rear surface 502 can be decreased, thereby decreasing the size of the housing 5 while the interference between the first unit 1A and the ECU 90 is suppressed. The first unit 1A is mounted to the surface 506 other than the bottom surface 503 to which the vehicle-body-side member (mount) is opposed on the housing 5. Thus, the area of the bottom surface 503 can be decreased, thereby decreasing the size of the housing 5 while the interference between the first unit 1A and the vehicle-body-side member (mount) is suppressed. The first unit 1A is mounted to the surface 506 other than the top surface 504 on which the ports 512 and 513 open on the housing 5. Thus, the area of the top surface 504 can be decreased, thereby decreasing the size of the housing 5 while the interference between the first unit 1A and the pipes 10W and 10R connected to the ports 512 and 513 is suppressed. The first unit 1A is mounted to the surface 506 other than the left side surface 505 to which the connector part 903 is opposed (adjacent) on the housing 5. Thus, the area of the left side surface 505 can be decreased, thereby decreasing the size of the housing 5 while the interference between the first unit 1A and the connector (harness) connected to the connector part 903 is suppressed.

The first unit 1A (housing 3) includes the connection liquid passages 304 and 305. Thus, a position and a direction of mounting the stroke simulator 4 (first unit 1A) to the second unit 1B can relatively freely be changed. In other words, independently of the position and the direction (attitude) of the stroke simulator 4 (chambers 401 and 402) with respect to the second unit 1B (housing 5), the chambers 401 and 402 and the liquid passages of the housing 5 can be connected to each other via the liquid passages 304 and 305. Therefore, ease of layout of the stroke simulator 4 with respect to the second unit 1B can be improved. As a result, when the second unit 1B including the stroke simulator 4 (first unit 1A) is mounted to the vehicle, the restriction on the layout thereof can be suppressed. Specifically, one end side of the first connection liquid passage 304 is connected to the positive-pressure chamber 401. The other end side (first simulator connection port 306A) of the liquid passage 304 opens on the outer surface of the housing 3. When the port 306A and the first unit connection port 514 of the second unit 1B (housing 5) are connected to each other, the positive-pressure chamber 401 and the positive-pressure liquid passage 16 of the second unit 1B are connected to each other. On this occasion, a position of the port 306A on the outer surface of the housing 3 can arbitrarily be set, and a position and an orientation of the positive-pressure chamber 401 (housing 3) with respect to the port 514 (housing 5) is thus not constrained. Thus, degrees of freedom in the position and the orientation of the first unit 1A with respect to the second unit 1B increase. Moreover, the position of the port 306A on the outer surface of the housing 3 can arbitrarily be set, and necessity for changing a position of the port 514 (positive-pressure liquid passage 16) of the second unit 1B connected to the port 306A on the housing 5 is low. In other words, ease of layout of the respective holes (ports, liquid passages, and the like) inside the housing 5 can be improved. As a result, the size and the weight of the housing 5 (the second unit 1B) can be decreased.

An axial center of the port 306A has an angle (more than 0 degrees) (is not parallel) with an axial center of the stroke simulator 4 (positive-pressure chamber 401), and extends in a direction bend with respect to the axial center of the stroke simulator 4. Thus, the provision of the first unit 1A in the housing 5 so that the axial center of the stroke simulator 4 extends in a normal line direction of the surface 506 of the housing 5 on which the port 514 opens can be avoided. As a result, an increase in dimension of the second unit 1B including the first unit 1A can be suppressed in the normal line direction, and restriction on the layout upon the mount to the vehicle can thus be suppressed. Specifically, the axial center of the port 306A is approximately orthogonal to the axial center of the stroke simulator 4. Thus, the axial center of the stroke simulator 4 is arranged approximately in parallel with the surface 506, and an increase in dimension in the normal line direction can be suppressed as much as possible. One end side of the second connection liquid passage 305 is connected to the back-pressure chamber 402. The other end side (second simulator connection port 306B) of the liquid passage 305 opens at any position on the outer surface of the housing 3. When the port 306B and the second unit connection port 515 of the second unit 1B (housing 5) are connected to each other, the back-pressure chamber 402 and the back-pressure liquid passage 17 of the second unit 1B are connected to each other. Moreover, an axial center of the port 306B has an angle (larger than 0 degrees) with respect to the axial center of the stroke simulator 4 (back-pressure chamber 402). Thus, the same actions and effects as described above are attained with such a configuration that the brake fluid flows out from the back-pressure chamber 402 as a result of the movement of the piston 41 through the brake operation by the driver.

The positive-pressure chamber 401 (small-diameter part 31) of the stroke simulator 4 (housing 3) is arranged on a side (positive side in the Z-axis direction) on which the master cylinder port 511 is positioned in a longitudinal direction (Z-axis direction) of the surface 506 with respect to the surface 506 of the housing 5. Specifically, at least a part of the positive-pressure chamber 401 is positioned on the positive side in the Z-axis direction with respect to the center in the Z-axis direction of the surface 506. Thus, the distance between the master cylinder port 511 and the positive-pressure chamber 401 can be decreased, and a total length of the positive-pressure liquid passage 16 connected to the secondary port 511S and the first connection liquid passage 304 connected to the positive-pressure chamber 401 can thus be decreased. As a result, the liquid passage 304 in the housing 3 can be simplified, thereby being capable of improving ease of layout inside the housing 3. Moreover, the liquid passage 16 in the housing 5 can be simplified, thereby being capable of improving ease of layout inside the housing 5. Thus, the size and the weight of the housing 3 (first unit 1A) or the housing 5 (second unit 1B), namely the size and the weight of the second unit 1B including the first unit 1A can be decreased. It is preferred that the liquid passage 304 open on the positive side in the Z-axis direction of the positive-pressure chamber 401 in order to smoothly supply the brake fluid from the liquid passage 304 to the positive-pressure chamber 401 even under a state in which the piston 41 is maximally displaced toward the positive side in the Z-axis direction. In this embodiment, at least a part of the positive side in the Z-axis direction of the positive-pressure chamber 401 is positioned on the positive side in the Z-axis direction of the surface 506. Thus, the distance between the port 511 and the chamber 401 can more efficiently be decreased.

The stroke simulator 4 (housing 3) extends along the longitudinal direction (Z-axis direction) of the surface 506. Specifically, (at least a part of) both ends in the axial direction of the housing 3 overlap the surface 506 as viewed in the X-axis direction. As a result, an extent in which the housing 3 and the surface 506 overlap each other as viewed from the X-axis direction increases. An extent of an outer surface of the housing 3 opposed to the surface 506 in the X-axis direction and an extent of the surface 506 opposed to the outer surface of the housing 3 in the X-axis direction increase in the Z-axis direction. Thus, an extent in the Z-axis direction in which the ports 306A and 306B opening on the outer surface of the housing 3 can be arranged increases. In other words, ease of layout of the ports 306 is improved. Thus, the liquid passages 304 and 305 connected to the ports 306 can be simplified. One end of the liquid passage 304 is connected to the positive-pressure chamber 401. One end of the liquid passage 305 is connected to the back-pressure chamber 402. The one ends of the liquid passages 304 and 305 are separated from each other in the Z-axis direction. The extent in which the ports 306A and 306B can be arranged is wide, and thus the one end and the other end (each of the ports 306A and 306B) of each of the liquid passages 304 and 305 can be, for example, at approximately the same positions in the Z-axis direction. As a result, the number of bent locations of the liquid passages 304 and 305 can be decreased, thereby simplifying the liquid passages 304 and 305. A base material of the housing 3 is formed by casting, and the liquid passages 304 and 305 and the like are formed by machining. Decrease in the number of the bent locations of the liquid passages 304 and 305 leads to decrease in the number of openings of the liquid passages 304 and 305 on the outer surface of the housing 3, thereby decreasing the number of times of sealing the openings by pressing in balls. The number of times of sealing through the balls (pressing-in) leads to decrease in stress acting on the housing 3, thereby increasing durability of the housing 3. Moreover, an extent in the Z-axis direction in which the ports 514 and 515 opening on the surface 506 can be arranged increases. In other words, ease of layout of the ports 514 and 515 is improved. Thus, the liquid passages 16 and 17 connected to the ports 514 and 515 can be simplified. As a result, the size and the weight of the housing 5 (the second unit 1B) can be decreased.

At least a part (first part 304A) of the liquid passage 304 extends on approximately the same straight line as the first bleeder liquid passage 307A. Thus, both the liquid passages 304A and 307A can be formed through the same machining process, and the productivity can thus be increased. Similarly, at least a part (first part 305A) of the liquid passage 305 extends on approximately the same straight line as the second bleeder liquid passage 307B, and productivity can thus be improved.

The end on the positive side in the Z-axis direction of the first unit 1A (housing 3) is positioned on the negative side in the Z-axis direction with respect to the end on the positive side in the Z-axis direction (top surface 504) of the second unit 1B (housing 5). Thus, a protrusion of the first unit 1A in the positive side in the Z-axis direction with respect to the second unit 1B can be suppressed, thereby being capable of suppressing an increase in dimension in the Z-axis direction of the second unit 1B including the first unit 1A. The end on the negative side in the Z-axis direction of the first unit 1A (housing 3) is positioned on the positive side in the Z-axis direction with respect to the end on the negative side in the Z-axis direction of the second unit 1B (ECU 90). Thus, a protrusion of the first unit 1A in the negative side in the Z-axis direction with respect to the second unit 1B can be suppressed, thereby being capable of suppressing an increase in dimension in the Z-axis direction of the second unit 1B including the first unit 1A.

The stroke simulator 4 extends along a gravity direction (a direction toward which the gravity acts, namely the vertical direction) under a state in which the stroke simulator 4 is mounted to the vehicle. Thus, when the first unit 1A is viewed in the gravity direction (Z-axis direction), the stroke simulator 4 is viewed in an approximate axial direction thereof. Therefore, an area of the first unit 1A as viewed in the gravity direction (Z-axis direction), namely a projected area in the gravity direction decreases. Thus, the projected area of the second unit 1B including the first unit 1A can be decreased, thereby increasing vehicle mountability thereof. Even when the axial center of the stroke simulator 4 is inclined slightly with respect to the gravity direction, the above-mentioned actions and effects can be attained as long as the above-mentioned projected area of the stroke simulator 4 is smaller than a projected area of the stroke simulator 4 in a direction orthogonal to the axial center of the stroke simulator 4. In this embodiment, the axial center of the stroke simulator 4 extends in the Z-axis direction. Thus, the projected area can be decreased as much as possible, and the increase in dimension of the first unit 1A in the horizontal direction (X-axis direction or Y-axis direction) can be suppressed under a state in which the stroke simulator 4 is mounted to the vehicle.

Axial centers (bleeder liquid passages 307A and 307B) of the bleeder parts 371 and 372 extend approximately in parallel with the surface 506. Thus, extensions of the bleeder parts 371 and 372 or protrusions of the bleeder valves BV in a normal-line direction (X-axis direction) of the surface 506 are suppressed. As a result, an increase in dimension of the second unit 1B including the first unit 1A can be suppressed in the normal-line direction, and restriction on the layout upon the mount to the vehicle can be suppressed. The axial centers (bleeder liquid passages 307A and 307B) of the bleeder parts 371 and 372 extend approximately in parallel with the axial direction of the motor housing 200 (Y-axis direction) toward the front surface 501 side. Thus, the bleeder parts 371 and 372 and the bleeder valves BV are arranged in a space between the first unit 1A (stroke simulator 4) and the motor housing 200 (tubular part 201). As a result, the size of the second unit 1B including the first unit 1A can be decreased, and an operation of air bleeding by opening or closing the bleeder valves BV can be facilitated.

The cylinder accommodation holes 53A to 53E are arrayed in a single row along an axial direction of the motor 20. The plurality of pump parts 2A to 2E overlap one another in the Y-axis direction. Thus, the cam unit 2U can be used in common by the plurality of pump parts 2A to 2E, thereby being capable of suppressing increases in the number of components and the cost. Moreover, the rotational drive shaft of the pump 2 can be shortened, thereby being capable of suppressing an increase in dimension of the housing 5 in the Y-axis direction. Moreover, the plurality of pump parts 2A to 2E overlap one another in the axial direction of the rotational drive shaft, a layout of the liquid passages can thus be simplified, and an increase in size of the housing 5 can be suppressed. The cylinder accommodating holes 53 are arranged on the front surface 501 side (on the side to which the motor 20 is mounted) of the housing 5. Therefore, the rotational drive shaft can be further shortened, and thus ease of layout inside the housing 5 can be improved. The plurality of valve accommodating holes are arrayed in the single row along the axial direction of the motor 20. As a result, the increase in dimension of the housing 5 in the Y-axis direction can be suppressed. The valve accommodating holes are arranged on the rear surface 502 side (side on which the ECU 90 is mounted) of the housing 5. Thus, electrical connectivity between the ECU 90 and solenoids of the electromagnetic valves 21 and the like can be improved. Specifically, the axial centers of the plurality of valve accommodating holes are approximately in parallel with the axial center of the motor 20, and all of the valve accommodating holes are opened on the rear surface 502. Thus, the solenoids of the electromagnetic valves 21 and the like can be arranged in a concentrated manner on the rear surface 502 of the housing 5, thereby being capable of simplifying electrical connections between the ECU 90 and the solenoids. Similarly, the plurality of sensor accommodating holes are arranged on the rear surface 502 side. Thus, the electrical connectivity between the ECU 90 and the hydraulic pressure sensors 91 and the like can be improved. The control board of the ECU 90 is arranged approximately in parallel with the rear surface 502. Thus, the electrical connection between the ECU 90 and the solenoids (and the sensors) can be simplified.

The plurality of the cylinder accommodating holes 53 and the valve accommodating holes at least partially overlap one another as viewed in the Y-axis direction. Thus, the area of the second unit 1B as viewed from the motor 20 side can be decreased. The housing 5 includes a pump region (pump part) and an electromagnetic valve region (electromagnetic valve part) arranged in the stated order from the front surface 501 side toward the rear surface 502 side along the axial direction of the motor 20. A region in which the cylinder accommodating holes 53 are located is the pump region, and a region in which the valve accommodating holes are located is the electromagnetic valve region, along the axial direction of the motor 20. The increase in dimension of the housing 5 in the axial direction of the motor 20 is easily suppressed by arranging the cylinder accommodating holes 53 and the valve accommodating holes in the respective regions in the axial direction of the motor 20 in this concentrated manner. Moreover, ease of layout of the respective elements in the housing 5 can be improved, and the size of the housing 5 can be decreased. In other words, the degree of freedom in layout of the plurality of holes on a plane orthogonal to the axial center of the motor 20 is improved in each of the regions. For example, the plurality of valve accommodating holes can easily be arranged so as to suppress an increase in dimension of the housing 5 on the plane in the electromagnetic valve region. Both the regions may partially overlap with each other in the axial center direction of the motor 20.

The wheel cylinder ports 512 are opened on the top surface 504. Thus, the space on the front surface 501 can be saved compared with a case in which the ports 512 are opened on the front surface 501, and the recessed parts 50A and 50B can easily be formed at the corners of the housing 5. The ports 512 are formed on the negative side in the Y-axis direction on the top surface 504. Thus, by forming the ports 512 in the electromagnetic valve region, the connection between the ports 512 and the SOL/V IN accommodating holes and the like is facilitated while the interference between the ports 512 and the cylinder accommodating holes 53 is avoided, thereby being capable of simplifying the liquid passages. The four ports 512 are arranged in a row in the X-axis direction on the negative side in the Y-axis direction on the top surface 504. Thus, an increase in dimension in the Y-axis direction of the housing 5 can be suppressed by forming the ports 512 arrayed in the single row in the Y-axis direction.

The master cylinder ports 511 are opened on the front surface 501. Thus, the space on the top surface 504 can be saved compared with a case in which the ports 511 are opened on the top surface 504, and the wheel cylinder ports 512 and the like can easily be formed on the top surface 504. The ports 511 overlap the motor housing 200 in the X-axis direction (as viewed in the Z-axis direction). Thus, an increase in dimension in the X-axis direction of the front surface 501 can be suppressed. The ports 511P and 511S are arranged on both sides of the first liquid reservoir chamber 521 in the X-axis direction (as viewed in the Y-axis direction). In other words, the first liquid reservoir chamber 521 is arranged between the ports 511P and 511S in the X-axis direction. The ease of layout inside the housing 5 can be improved, and the area of the front surface 501 can be decreased, thereby decreasing the size of the housing 5 by using the space between the ports 511P and 511S to form the first liquid reservoir chamber 521 in this way. The ports 511P and 511S are arranged respectively between the chamber 521 and the cylinder accommodating holes 53C and 53D in the circumferential direction of the axial center O (as viewed from the Y-axis direction). Thus, an increase in dimension from the axial center O to the outer surface (top surface 504) of the housing 5 can be suppressed, thereby being capable of decreasing the size of the housing 5. Moreover, the openings of the ports 511 on the front surface 501 can be arranged on a center side in the X-axis direction, thereby facilitating formation of the recessed parts 50A and 50B on outer sides in the X-axis direction with respect to the ports 511P and 511S. A volume of the front surface 501 side and the top surface 504 side of the housing 5 is decreased by volumes of the recessed parts 50A and 50B, and the weight is thus decreased. The suction port 513 exists on the positive side in the Y-axis direction (in a pump region). Thus, connection of the port 513 (first liquid reservoir chamber 521) to the cylinder accommodating holes 53 (suction parts of the pump parts 2C and 2D) is facilitated, and the liquid passages can thus be simplified. The port 513 exists on the center side in the X-axis direction. Thus, when the one chamber 521 is used in common by both the P and S systems, the port 513 (chamber 521) can easily be connected to the valve accommodating holes in the both systems, and the liquid passages can thus be simplified. The wheel cylinder ports 512c and 512d are arranged on both sides of the suction port 513 (chamber 521), and the openings of the ports 512c and 512d and the port 513 (chamber 521) partially overlap each other, in the X-axis direction (as viewed in the Y-axis direction). Thus, an increase in size in the X-axis direction of the housing 5 can be suppressed, thereby decreasing the size. The axial center of the first reservoir chamber 521 extends in the direction orthogonal to the axial center O, the chamber 521 opens on the outer surface (top surface 504) of the housing 5 crossing this direction (extending along the circumferential direction of the axial center O), and this opening functions as the suction port 513. Thus, an increase in dimension from the axial center O to the outer surface (the top surface 504 on which the chamber 521 opens) of the housing 5 extending along the circumferential direction of the axial center O can be suppressed, thereby being capable of decreasing the size of the housing 5.

The first liquid reservoir chamber 521, the power supply hole 55, and the second liquid reservoir chamber 522 are formed in a region between the cylinder accommodating holes 53 adjacent to each other in the circumferential direction of the axial center O. Thus, the suction liquid passage 12 connecting the chamber 521 and the suction parts of the pump parts 2C and 2D to each other can thus be shortened. Moreover, the ease of layout (volume efficiency) inside the housing 5 can be improved, and the area of the front surface 501 can be decreased, thereby being capable of decreasing the size of the housing 5 by using the space between the holes 53 adjacent to each other to form the chambers 521 and 522 and the hole 55. The chamber 521 is arranged in a region surrounded by the master cylinder ports 511P and 511S and the wheel cylinder ports 512c and 512d. Specifically, the chamber 521 overlaps each of the above-mentioned port 511P and the like in the Z-axis direction, and is arranged inside a quadrangle formed by connecting the port 511P and the like to each other with line segments as viewed in the Z-axis direction. The ease of layout inside the housing 5 is improved, and the size of the housing 5 can be decreased by using the space between the port 511P and the like to form the chamber 521 in this way. The axial center of the second reservoir chamber 522 extends in the direction orthogonal to the axial center O, and the chamber 522 opens on the outer surface (bottom surface 503) of the housing 5 crossing this direction (extending along the circumferential direction of the axial center O). Thus, an increase in dimension from the axial center O to the outer surface (the bottom surface 503 on which the chamber 522 opens) of the housing 5 extending along the circumferential direction of the axial center O can be suppressed, thereby decreasing the size of the housing 5. The holes 53A to 53E and the chamber 522 partially overlap each other in the Y-axis direction (as viewed in the X-axis direction). Thus, the increase in dimension in the Y-axis direction of the housing 5 can be suppressed, thereby being capable of decreasing the size. The chamber 522 opens on the bottom surface 503 on the positive side in the Y-axis direction. Thus, the chamber 522 is easily be connected to the region, in which the holes 53A to 53E open, in the cam accommodating hole, and the drain liquid passage can thus be simplified.

The pin holes 569 for the fixing to the mount are provided in the bottom surface 503 of the housing 5. The holes 569 open on the bottom surface 503, and extend in the vertical direction (Z-axis direction). The pin fixed to the hole 569 and the insulator fitted to the pin also extend in the vertical direction. Thus, the insulator can receive the weight (load caused by the gravity acting downward in the vertical direction) of the second unit 1B in an axial direction thereof, and efficiently support the load in the vertical direction, to thereby stably support the second unit 1B with respect to the vehicle body side (mount). The bolt holes 567 and 568 for fixing to the mount are provided on the bottom side in the vertical direction with respect to the axial center O on the front surface 501 of the housing 5. The holes 567 and 568 open on the front surface 501, and extend in the horizontal direction. The second unit 1B can stably be held by supporting the bottom surface 503 and the front surface 501 of the housing 5. A support part of the bottom surface 503 and a support part of the front surface 501 are different in a direction of supporting the housing 5, and a support strength can be increased for a load that can act on the housing 5 in many directions. The pin holes 569 are arranged on the negative side in the Y-axis direction on the bottom surface 503. A distance between the support part (bolt holes 567 and 568) on the front surface 501 and the support part (pin holes 569) on the bottom surface 503 can thus be long, thereby being capable of more stably supporting the second unit 1B. Stability of providing the second unit 1B can be increased by positioning the center of gravity of the second unit 1B on the bottom side in the vertical direction. The first recessed part 50A and the second recessed part 50B are left open on the top surface 504. The weight of the top surface 504 side of the housing 5 is decreased by weights corresponding to the recessed parts 50A and 50B. Therefore, the center of gravity of the second unit 1B can easily be positioned on the bottom side in the vertical direction. Moreover, the stability of providing the second unit 1B including the first unit 1A can be increased by positioning the center of gravity of the first unit 1A on the bottom side in the vertical direction. The positive-pressure chamber 401 (small-diameter part 31) is arranged on the positive side in the Z-axis direction with respect to the back-pressure chamber 402 (large-diameter part 33). The weight on the small-diameter part 31 side is more easily decreased than the large-diameter part 33 side. Therefore, the center of gravity of the first unit 1A can easily be positioned on the bottom side in the vertical direction.

(Improvement in Workability)

The master cylinder ports 511 and the wheel cylinder ports 512 are arranged on the top side in the vertical direction of the housing 5. Thus, workability of respectively mounting the pipes 10MP, 10MS, and 10W to the ports 511 and 512 of the housing 5 provided on the vehicle body side can be improved. The wheel cylinder ports 512 open on the top surface 504. Therefore, the workability can further be improved. The master cylinder ports 511 open at the end on the top side in the vertical direction of the front surface 501. Therefore, the workability can further be improved. Moreover, routing of the pipe connected to the suction port 513 can be facilitated by arranging the suction port 513 communicating with the first liquid reservoir chamber 521 on the top surface 504. Moreover, work from above is easy upon the mounting to the vehicle.

When the pipe 10M is fixed to the port 511 on the front surface 501, a tool is used to tighten a nut. The tool approaches the front surface 501. When parts of the bolts b2 for mounting the ECU 90 to the rear surface 502 protrude from the front surface 501, the tightening the nut through the tool is difficult. In this embodiment, the parts (head parts) of the bolts b2 protrude respectively in the first recessed part 50A and the second recessed part 50B. In other words, parts of the bolts b2 do not protrude from the front surface 501 except for the recessed parts 50A and 50B. Thus, interference between the parts of the bolts b2 and the tool is suppressed, and the operation of using the tool to fix the pipe 10M to the port 511 is facilitated. The cylinder accommodating holes 53C and 53D open in the recessed parts 50A and 50B, respectively. Thus, an increase in dimension in the axial direction of the holes 53C and 53D can be suppressed, thereby being capable of increasing ease of assembly of the pump components to the holes 53C and 53D.

A space for the air bleeding is required in a vicinity of the bleeder valves BV. At least one of the valves BV is arranged on the top side (positive side in the Z-axis direction) in the vertical direction of the housing 3. The existence of the valve BV on the top side in the vertical direction can facilitate the air bleeding by opening or closing the valve BV. The valves BV (ports 308) are directed toward the Y-axis direction side. Thus, a space adjacent in the X-axis direction to the second unit 1B including the first unit 1A can be decreased. The valves BV (ports 308) are directed toward the front surface 501 side (positive side in the Y-axis direction). An end on the positive side in the Y-axis direction of the housing 3 is on the negative side in the Y-axis direction with respect to an end on the positive side in the Y-axis direction of the motor housing 200 (refer to FIG. 8). Thus, a space between both of the housings 3 and 200 can be used to arrange the valves BV, thereby being capable of decreasing the size of second unit 1B including the first unit 1A.

### Second Embodiment

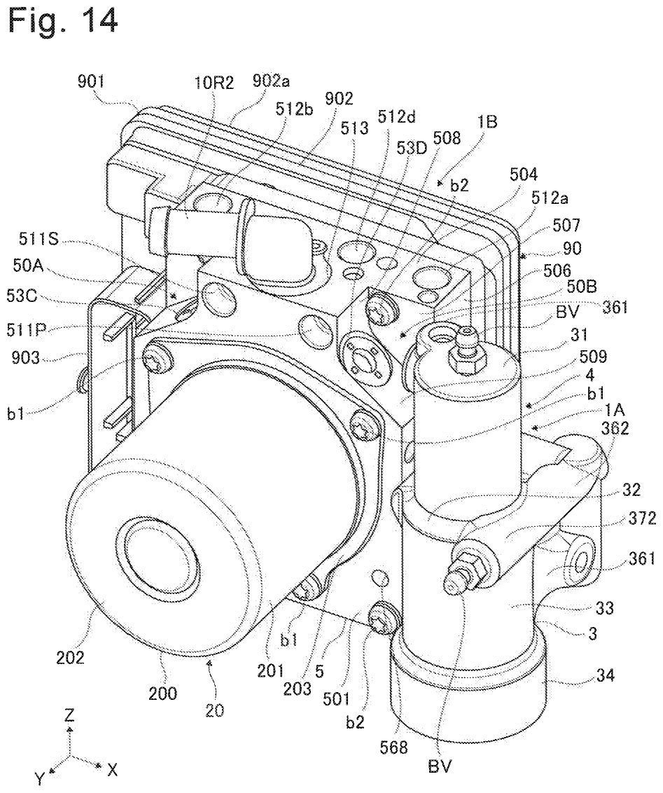

First, description is given of a configuration. In the following, configurations common to those of the first embodiment are denoted by the same reference numerals as those of the first embodiment, and description thereof is omitted. FIG. 14 is a perspective view for illustrating the second unit 1B under a state in which the first unit 1A in this embodiment is mounted, as viewed from the positive side in the X-axis direction, the positive side in the Y-axis direction, and the positive side in the Z-axis direction. The first connection liquid passage in the first liquid passage part 361 includes a first part, a second part, and a third part. One end of the first part is connected to the positive-pressure chamber 401 on the positive side in the Z-axis direction of the small-diameter part 31, and extends over a short distance toward the negative side in the X-axis direction and the negative side in the Y-axis direction. One end of the second part is connected to the other end of the first part, and extends toward the negative side in the Z-axis direction. The third part extends from the other end of the second part toward the negative side in the X-axis direction, and is connected to the first simulator connection port. The second connection liquid passage in the second liquid passage part 362 includes a first part, a second part, and a third part. One end of the first part is connected to the back-pressure chamber 402 on the positive side in the Z-axis direction of the large-diameter part 31, and extends toward the negative side in the Y-axis direction. One end of the second part is connected to the other end of the first part, and extends toward the negative side in the Z-axis direction. The third part extends from the other end of the second part toward the negative side in the X-axis direction, and is connected to the second simulator connection port 306B. The second bleeder part 372 is arranged on the positive side in the X-axis direction of the large-diameter part 33, and protrudes toward the positive side in the Y-axis direction. Inside the second bleeder part 372, the second bleeder liquid passage extends in the Y-axis direction on approximately the same axial center as the first part of the second connection liquid passage. On the surface 506, the first unit connection port of the second unit 1B is provided at approximately the same position as the second unit connection port 515 of the first embodiment. The second unit connection port is provided slightly in the negative side in the Y-axis direction, and on the negative side in the Z-axis direction with respect to the first unit connection port. The first bleeder part 371 is not provided, and the bleeder valve BV is directly provided on an end surface on the positive side in the Z-axis direction of the small-diameter part 31. The other configuration is the same as that of the first embodiment.

Next, description is given of actions and effects. The bleeder valve BV is arranged at a top end in the vertical direction (end on the positive side in the Z-axis direction) of the stroke simulator 4, and is directed toward the top side in the vertical direction (positive side in the Z-axis direction). Thus, the air bleeding through the valve BV can be facilitated. The other actions and effects are the same as those of the first embodiment.

### Third Embodiment

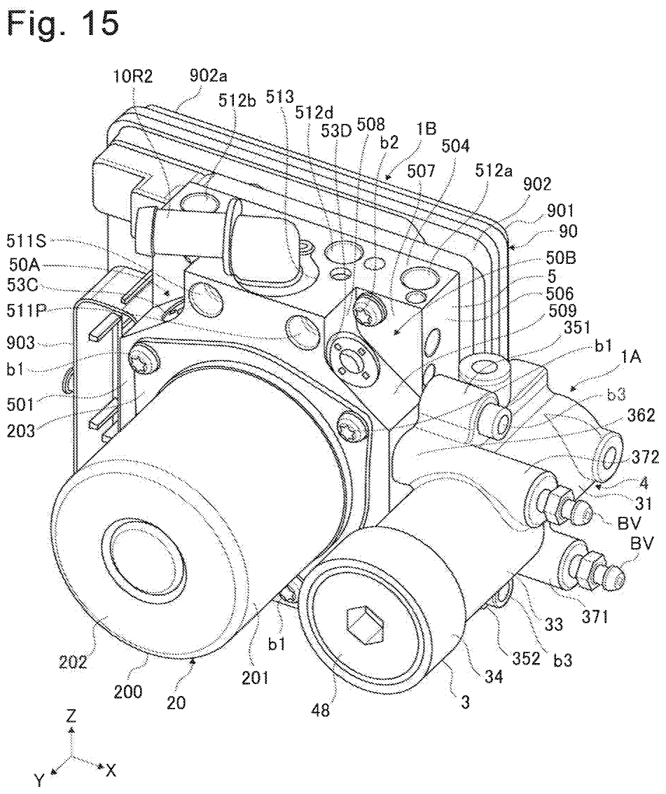

First, description is given of a configuration. In the following, configurations common to those of the first embodiment are denoted by the same reference numerals as those of the first embodiment, and a description thereof is omitted. FIG. 15 is a perspective view for illustrating the second unit 1B under a state in which the first unit 1A in this embodiment is mounted, as viewed from the positive side in the X-axis direction, the positive side in the Y-axis direction, and the positive side in the Z-axis direction. The axial center of the stroke simulator 4 extends in the Y-axis direction. The large-diameter part 33 (back-pressure chamber 402) is provided on the positive side in the Y-axis direction, and the small-diameter part 31 (positive-pressure chamber 401) is provided on the negative side in the Y-axis direction. The second liquid passage part 362 protrudes from the negative side in the Y-axis direction and the positive side in the Z-axis direction of the large-diameter part 33 toward the negative side in the X-axis direction. The first bleeder part 371 protrudes from the positive side in the Y-axis direction and the negative side in the Z-axis direction of the small-diameter part 31 toward the positive side in the X-axis direction. The second bleeder part 372 protrudes from the negative side in the Y-axis direction and the positive side in the Z-axis direction of the large-diameter part 33 toward the positive side in the X-axis direction. The bleeder valves BV are arranged at ends on the positive side in the X-axis direction of the respective bleeder parts 371 and 372. The second connection liquid passage in the second liquid passage part 362 and the second bleeder liquid passage in the second bleeder part 372 extend in the X-axis direction on approximately the same axes. On the right side surface 506, the second unit connection port is provided at a position adjacent to the negative side in the Z-axis direction of the recessed part 50B. The other configuration is the same as that of the first embodiment.

Next, description is given of actions and effects. The stroke simulator 4 extends in a widthwise direction (Y-axis direction) on the right side surface 506. Therefore, an area of the first unit 1A as viewed in the widthwise direction (Y-axis direction), namely a projected area in the widthwise direction decreases. Thus, the projected area of the second unit 1B including the first unit 1A can be decreased. Moreover, even when the arrangement configuration in which the stroke simulator 4 extends along a longitudinal direction of the surface 506 to which the first unit 1A is mounted is restricted in terms of the layout on the vehicle body side when the second unit 1B including the first unit 1A is mounted to the vehicle, these units 1A and 1B can easily be provided on the vehicle body side.

The stroke simulator 4 extends in the horizontal direction under the state in which the stroke simulator 4 is mounted to the vehicle. Thus, even when the arrangement configuration in which the stroke simulator 4 extends along the gravity direction is restricted in terms of the layout on the vehicle body side when the second unit 1B including the first unit 1A is mounted to the vehicle, these units 1A and 1B can easily be provided on the vehicle body side. Other actions and effects are the same as those of the first embodiment.

### Other Embodiments

The embodiments of the present invention have been described based on the drawings. However, the specific configuration of the present invention is not limited to the configuration described in each of the embodiments. A change in design without departing from the scope of the gist of the invention is encompassed in the present invention. Further, within a range in which the above-mentioned problems can be at least partially solved or within a range in which the above-mentioned effects are at least partially obtained, a suitable combination or omission of the components recited in the claims and described in the specification is possible. For example, specific shapes of the housings 3 and 5 are not limited to those of the embodiments. Specific structures (the number of the springs and the arrangement of the dampers and the like) of the stroke simulator 4 are not limited to those of the embodiments.

Description is now given of technical ideas which can be recognized from the embodiments described above. In one aspect, the hydraulic pressure control device includes a stroke simulator unit and a hydraulic pressure unit. The stroke simulator unit includes a stroke simulator, a simulator connection liquid passage, and a simulator connection port. The stroke simulator is independent of a master cylinder configured to generate a hydraulic pressure through a brake pedal operation, and is configured to generate a reaction force against the brake pedal operation. The simulator connection liquid passage has one end side connected to the stroke simulator. The simulator connection port is provided on an opposite end side of the simulator connection liquid passage. The stroke simulator is mounted to the hydraulic pressure unit. The hydraulic pressure unit includes a unit connection port and a liquid passage, and is configured to generate a hydraulic pressure in a wheel cylinder of a vehicle via the liquid passage. The unit connection port is connected to the simulator connection port, and overlaps the simulator connection port as viewed in an axial direction of the simulator connection port. The liquid passage is connected to the unit connection port. In a more preferred aspect, in the above-mentioned aspect, the stroke simulator includes a piston which defines a first chamber and second chamber in a cylinder. The simulator connection liquid passage includes a first liquid passage connected to the first chamber on the one end side and a second liquid passage connected to the second chamber on the one end side. In another preferred aspect, in any one of the above-mentioned aspects, the hydraulic pressure unit includes a housing, a hydraulic pressure source, and a motor. The housing internally includes the liquid passage. The hydraulic pressure source is provided inside the housing, and is configured to generate the hydraulic pressure in the wheel cylinder via the liquid passage. The motor is mounted to one surface of surfaces of the housing, and is configured to operate the hydraulic pressure source. The stroke simulator unit is mounted to another surface of the surfaces of the housing which surface is different from the surface to which the motor is mounted. In another preferred aspect, in any one of the above-mentioned aspects, the stroke simulator extends in a longitudinal direction of the surface of the surfaces of the housing to which surface the stroke simulator unit is mounted. In another preferred aspect, in any one of the above-mentioned aspects, the hydraulic pressure unit includes a switching electromagnetic valve configured to switch absence and presence of an inflow of working fluid to the stroke simulator. In another preferred aspect, in any one of the above-mentioned aspects, the surfaces of the housing include a first surface, a second surface, a third surface, and a fourth surface. The motor is mounted to the first surface. The second surface is opposed to the first surface across the housing, and a control unit configured to drive the hydraulic pressure source and the switching electromagnetic valve are arranged on the second surface. The third surface continues to the first surface and the second surface, and a wheel cylinder connection port to which a pipe connected to the wheel cylinder is connected is arranged on the third surface. The fourth surface continues to the first surface, the second surface, and the third surface, and the unit connection port is arranged on the fourth surface. In another preferred aspect, in any one of the above-mentioned aspects, the surfaces of the housing include a fifth surface, which is opposed to the fourth surface across the housing, and to which a connector configured to electrically connect the control unit to an external device (for example, the connector part 903 in the above-mentioned embodiments) is opposed. In another preferred aspect, in any one of the above-mentioned aspects, the surfaces of the housing include a sixth surface, which is opposed to the third surface across the housing, and on which a hole for fixing the housing to a vehicle body side of the vehicle opens. In another preferred aspect, in any one of the above-mentioned aspects, the stroke simulator extends in a widthwise direction of the surface of the surfaces of the housing to which surface the stroke simulator unit is mounted. In another preferred aspect, in any one of the above-mentioned aspects, the stroke simulator extends in a gravity direction under a state in which the stroke simulator is mounted to the vehicle. In another preferred aspects, in any one of the above-mentioned aspects, the stroke simulator extends in a horizontal direction under a state in which the stroke simulator is mounted to the vehicle. In another preferred aspects, in any one of the above-mentioned aspects, the stroke simulator includes a piston defining a first chamber and second chamber in a cylinder. The brake fluid flowing out from the master cylinder as a result of a brake operation by a driver flows into the first chamber, and the piston moves. According to the movement of the piston, the brake fluid flows out from the second chamber. The simulator connection liquid passage includes a first liquid passage connected to the first chamber on the one end side and a second liquid passage connected to the second chamber on the one end side. A master cylinder connection port to which a pipe connected to the master cylinder is connected opens on a surface of the housing. The first chamber is arranged on a side on which the master cylinder connection port is positioned in a longitudinal direction of the surface of the surfaces of the housing to which surface the stroke simulator unit is mounted with respect to the surface to which the stroke simulator unit is mounted.

Further, from another viewpoint, in one aspect, a hydraulic pressure control device includes a stroke simulator unit and a hydraulic pressure unit. The stroke simulator unit includes a stroke simulator, a simulator connection liquid passage, and a simulator connection port. The stroke simulator is independent of a master cylinder configured to generate a hydraulic pressure through a brake pedal operation, and is configured to generate a reaction force against the brake pedal operation. The simulator connection liquid passage has one end side connected to the stroke simulator. The simulator connection port is provided on an opposite end side of the simulator connection liquid passage. The stroke simulator unit is mounted to the hydraulic pressure unit. The hydraulic pressure unit includes a housing including a liquid passage connecting a wheel cylinder configured to generate a braking force in a wheel of a vehicle, and the master cylinder to each other. Surfaces of the housing include a first surface, a second surface, a third surface, and a fourth surface. A motor configured to drive a hydraulic pressure source configured to generate an operation hydraulic pressure in the wheel cylinder via the liquid passage is mounted to the first surface. A control unit configured to drive the hydraulic pressure source is arranged on the second surface. A wheel cylinder connection port to which a pipe connected to the wheel cylinder is connected is arranged on the third surface. A unit connection port connected to the simulator connection port and overlapping the simulator connection port as viewed in an axial direction of the simulator connection port is arranged on the fourth surface. The second surface is opposed to the first surface across the housing. The third surface continues to the first surface and the second surface. The fourth surface continues to the first surface, the second surface, and the third surface. In a more preferred aspect, in the above-mentioned aspect, the stroke simulator includes a piston defining a first chamber and second chamber in a cylinder. The simulator connection liquid passage includes a first liquid passage connected to the first chamber on the one end side and a second liquid passage connected to the second chamber on the one end side. In another preferred aspect, in any one of the above-mentioned aspects, the surfaces of the housing include a fifth surface, which is opposed to the fourth surface across the housing, and to which a connector for electrically connecting the control unit to an external device is opposed. In another preferred aspect, in any one of the above-mentioned aspects, the surfaces of the housing include a sixth surface, which is opposed to the third surface across the housing, and on which a hole for fixing the housing to a vehicle body side of the vehicle opens. In another preferred aspect, in any one of the above-mentioned aspects, the stroke simulator extends in a longitudinal direction of the surface of the surfaces of the housing to which surface the stroke simulator unit is mounted. In another preferred aspect, in any one of the above-mentioned aspects, the hydraulic pressure unit includes a switching electromagnetic valve configured to switch absence and presence of an inflow of working fluid to the stroke simulator. In another preferred aspect, in any one of the above-mentioned aspects, the stroke simulator extends in a widthwise direction of the surface of the surfaces of the housing to which surface the stroke simulator unit is mounted.

In one aspect, a braking system includes a first unit, a second unit, and a third unit. The first unit includes a stroke simulator, a simulator connection liquid passage, and a simulator connection port. The stroke simulator is configured to generate a reaction force against a brake pedal operation. The simulator connection liquid passage has one end side connected to the stroke simulator. The simulator connection port is provided on an opposite end side of the simulator connection liquid passage. The first unit is connected to the second unit. The second unit is configured to generate a hydraulic pressure in a wheel cylinder of a vehicle via a liquid passage. The second unit includes a unit connection port and a liquid passage. The unit connection port is connected to the simulator connection port, and overlaps the simulator connection port as viewed in an axial direction of the simulator connection port. The liquid passage is connected to the unit connection port. The third unit is connected to the second unit via a pipe, and includes a master cylinder configured to generate a hydraulic pressure through the brake pedal operation. In a more preferred aspect, in the above-mentioned aspect, the stroke simulator includes a piston defining a first chamber and second chamber in a cylinder. The simulator connection liquid passage includes a first liquid passage connected to the first chamber on the one end side and a second liquid passage connected to the second chamber on the one end side. In another preferred aspect, in any one of the above-mentioned aspects, the second unit includes a housing, a hydraulic pressure source, and a motor. The housing internally includes the liquid passage. The hydraulic pressure source is provided inside the housing, and is configured to generate the operation hydraulic pressure in the wheel cylinder via the liquid passage. The motor is mounted to one surface of surfaces of the housing, and is configured to operate the hydraulic pressure source. The first unit is mounted to another surface of the surfaces of the housing which surface is different from the surface to which the motor is mounted. In another preferred aspect, in any one of the above-mentioned aspects, the stroke simulator extends in a longitudinal direction of the surface of the surfaces of the housing to which surface the first unit is mounted. In another preferred aspect, in any one of the above-mentioned aspects, the second unit includes a switching electromagnetic valve configured to switch absence and presence of an inflow of working fluid to the stroke simulator.

The present application claims priority to the Japanese Patent Application No. 2015-227291 filed on Nov. 20, 2015. The entire disclosure including the specification, the claims, the drawings, and the abstract of Japanese Patent Application No. 2015-227291 filed on Nov. 20, 2015 is incorporated herein in its entirety by reference.

### REFERENCE SIGNS LIST

1 braking system, 1A first unit (stroke simulator unit), 1B second unit (hydraulic pressure unit), 11 supply liquid passage, 16 positive-pressure liquid passage, 17 back-pressure liquid passage, 304 first connection liquid passage (simulator connection liquid passage, first liquid passage), 305 second connection liquid passage (simulator connection liquid passage, second liquid passage), 306A first simulator connection port, 306B second simulator connection port, 4 stroke simulator, 514 first unit connection port, 515 second unit connection port, 7 master cylinder, BP brake pedal, W/C wheel cylinder

1. A hydraulic pressure control device comprising:
a stroke simulator unit; and
a hydraulic pressure unit,
wherein the stroke simulator unit includes:
a stroke simulator which is independent of a master cylinder configured to generate a hydraulic pressure through a brake pedal operation, and is configured to generate a reaction force against the brake pedal operation;
a simulator connection liquid passage having one end side and an opposite end side, the one end side being connected to the stroke simulator; and
a simulator connection port provided on the opposite end side of the simulator connection liquid passage,
wherein the stroke simulator unit is mounted to the hydraulic pressure unit,
wherein the hydraulic pressure unit includes:
a unit connection port which is connected to the simulator connection port, and overlaps the simulator connection port as viewed in an axial direction of the simulator connection port; and
a liquid passage connected to the unit connection port, and
wherein the hydraulic pressure unit is configured to generate a hydraulic pressure in a wheel cylinder of a vehicle via the liquid passage.

2. The hydraulic pressure control device according to claim 1,
wherein the stroke simulator includes a piston defining a first chamber and second chamber in a cylinder, and
wherein the simulator connection liquid passage includes a first liquid passage connected to the first chamber on the one end side and a second liquid passage connected to the second chamber on the one end side.

3. The hydraulic pressure control device according to claim 2,
wherein the hydraulic pressure unit includes:
a housing internally including the liquid passage;
a hydraulic pressure source provided inside the housing, and configured to generate the hydraulic pressure in the wheel cylinder via the liquid passage; and
a motor mounted to one surface of surfaces of the housing, and configured to operate the hydraulic pressure source, and
wherein the stroke simulator unit is mounted to another surface of the surfaces of the housing which surface is different from the surface to which the motor is provided.

4. The hydraulic pressure control device according to claim 3, wherein the stroke simulator extends in a longitudinal direction of the surface of the surfaces of the housing to which surface the stroke simulator unit is mounted.

5. The hydraulic pressure control device according to claim 4, wherein the hydraulic pressure unit includes a switching electromagnetic valve configured to switch absence and presence of an inflow of working fluid to the stroke simulator.

6. The hydraulic pressure control device according to claim 5, wherein the surfaces of the housing include:
a first surface to which the motor is mounted;
a second surface which is opposed to the first surface across the housing, and on which a control unit configured to drive the hydraulic pressure source and the switching electromagnetic valve is arranged;
a third surface which continues to the first surface and the second surface, and on which a wheel cylinder connection port connected to a pipe connected to the wheel cylinder is arranged; and
a fourth surface which continues to the first surface, the second surface, and the third surface, and on which the unit connection port is arranged.

7. The hydraulic pressure control device according to claim 6, wherein the surfaces of the housing include a fifth surface which is opposed to the fourth surface across the housing, and to which a connector for electrically connecting the control unit to an external device is opposed.

8. The hydraulic pressure control device according to claim 7, wherein the surfaces of the housing include a sixth surface which is opposed to the third surface across the housing, and on which a hole for fixing the housing to a vehicle body side of the vehicle opens.

9. The hydraulic pressure control device according to claim 3, wherein the stroke simulator extends in a widthwise direction of the surface of the surfaces of the housing to which surface the stroke simulator unit is mounted.

10. The hydraulic pressure control device according to claim 3, wherein the stroke simulator extends in a gravity direction under a state in which the stroke simulator is mounted to the vehicle.

11. The hydraulic pressure control device according to claim 3, wherein the stroke simulator extends in a horizontal direction under a state in which the stroke simulator is mounted to the vehicle.

12. A hydraulic pressure control device comprising:
a stroke simulator unit; and
a hydraulic pressure unit,
wherein the stroke simulator unit includes:
a stroke simulator which is independent of a master cylinder configured to generate a hydraulic pressure through a brake pedal operation, and is configured to generate a reaction force against the brake pedal operation;
a simulator connection liquid passage having one end side and an opposite end side, the one end side being connected to the stroke simulator; and
a simulator connection port provided on the opposite end side of the simulator connection liquid passage,
wherein the stroke simulator unit is mounted to the hydraulic pressure unit,
wherein the hydraulic pressure unit includes a housing including a liquid passage connecting a wheel cylinder configured to generate a braking force in a wheel of a vehicle, and the master cylinder to each other,
wherein surfaces of the housing include:
a first surface to which a motor configured to drive a hydraulic pressure source configured to generate an operation hydraulic pressure in the wheel cylinder via the liquid passage is mounted;
a second surface on which a control unit configured to drive the hydraulic pressure source is arranged;
a third surface on which a wheel cylinder connection port connected to a pipe connected to the wheel cylinder is arranged; and
a fourth surface on which a unit connection port connected to the simulator connection port and overlapping the simulator connection port as viewed in an axial direction of the simulator connection port is arranged,
wherein the second surface is opposed to the first surface across the housing,
wherein the third surface continues to the first surface and the second surface, and
wherein the fourth surface continues to the first surface, the second surface, and the third surface.

13. The hydraulic pressure control device according to claim 12,
wherein the stroke simulator includes a piston defining a first chamber and second chamber in a cylinder, and
wherein the simulator connection liquid passage includes a first liquid passage connected to the first chamber on the one end side and a second liquid passage connected to the second chamber on the one end side.

14. The hydraulic pressure control device according to claim 13, wherein the surfaces of the housing include a fifth surface which is opposed to the fourth surface across the housing, and to which a connector for electrically connecting the control unit to an external device is opposed.

15. The hydraulic pressure control device according to claim 14, wherein the surfaces of the housing include a sixth surface which is opposed to the third surface across the housing, and on which a hole for fixing the housing to a vehicle body side of the vehicle opens.

16. The hydraulic pressure control device according to claim 15, wherein the stroke simulator extends in a longitudinal direction of the surface of the surfaces of the housing to which surface the stroke simulator unit is mounted.

17. The hydraulic pressure control device according to claim 16, wherein the hydraulic pressure unit includes a switching electromagnetic valve configured to switch absence and presence of an inflow of working fluid to the stroke simulator.

18. The hydraulic pressure control device according to claim 15, wherein the stroke simulator extends in a widthwise direction of the surface of the surfaces of the housing to which surface the stroke simulator unit is mounted.

19. A braking system comprising:
a first unit;
a second unit; and
a third unit,
wherein the first unit includes:
a stroke simulator configured to generate a reaction force against the brake pedal operation;
a simulator connection liquid passage having one end side and an opposite end side, the one end side being connected to the stroke simulator; and
a simulator connection port provided on the opposite end side of the simulator connection liquid passage,
wherein the first unit is mounted to the second unit,
wherein the second unit includes:
a unit connection port connected to the simulator connection port, and overlapping the simulator connection port as viewed in an axial direction of the simulator connection port; and
a liquid passage connected to the unit connection port,
wherein the second unit is configured to generate a hydraulic pressure in a wheel cylinder of a vehicle via the liquid passage,
wherein the third unit is connected to the second unit via a pipe, and
wherein the third unit includes a master cylinder configured to generate a hydraulic pressure through a brake pedal operation.

20. The braking system according to claim 19,
wherein the stroke simulator includes a piston defining a first chamber and second chamber in a cylinder, and
wherein the simulator connection liquid passage includes a first liquid passage connected to the first chamber on the one end side and a second liquid passage connected to the second chamber on the one end side.

21. The braking system according to claim 20,
wherein the second unit includes:
a housing internally including the liquid passage;
a hydraulic pressure source provided inside the housing, and configured to generate an operation hydraulic pressure in the wheel cylinder via the liquid passage; and
a motor mounted to one surface of surfaces of the housing, and configured to operate the hydraulic pressure source, and
wherein the first unit is mounted to another surface of the surfaces of the housing which surface is different from the surface to which the motor is mounted.

22. The braking system according to claim 21, wherein the stroke simulator extends in a longitudinal direction of the surface of the surfaces of the housing to which surface the first unit is mounted.

23. The braking system according to claim 22, wherein the second unit includes a switching electromagnetic valve configured to switch absence and presence of an inflow of working fluid to the stroke simulator.
